(19) United States
(12) Patent Application Publication
(10) Pub. No.: US 2026/0186489 A1
(43) Pub. Date: Jul. 2, 2026

(54) TRAVEL CONTROL SYSTEM, WORK VEHICLE, METHOD OF TRAVEL CONTROL, AND COMPUTER PROGRAM

(71) Applicant: Kubota Corporation, Osaka (JP)

(72) Inventors: Tomohiro KINOSHITA, Sakai-shi (JP); Tsuyoshi HARADA, Sakai-shi (JP)

(21) Appl. No.: 19/428,876

(22) Filed: Dec. 22, 2025

(30) Foreign Application Priority Data
Dec. 27, 2024 (JP) 2024-231911

(51) Int. Cl. G05D 1/229; G05D 1/648; G05D 107/20

(52) U.S. Cl. CPC G05D 1/2297; G05D 1/648; G05D 2107/21

(57) ABSTRACT

A travel control system includes a positioning device to output position data of a work vehicle, and a controller configured or programmed to control operation of the work vehicle, operate in a recording mode to store path data concerning a path traveled by the work vehicle including waypoint data acquired based on the position data while the work vehicle is traveling, operate in a reproducing mode to control the operation of the work vehicle while causing the work vehicle to travel via self-driving based on the path data, classify, based on the path data, the path into a first section having a curvature equal to or less than a threshold and a second section having a curvature greater than the threshold, and vary a control method for operation of the work vehicle in the reproducing mode between the first and second sections.

### CROSS REFERENCE TO RELATED APPLICATIONS

This application claims the benefit of priority to Japanese Patent Application No. 2024-231911 filed on Dec. 27, 2024. The entire contents of this application are hereby incorporated herein by reference.

### BACKGROUND OF THE INVENTION

### 1. Field of the Invention

The present invention relates to travel control systems, work vehicles, methods of travel control, and non-transitory computer-readable media including computer programs.

### 2. Description of the Related Art

As attempts in next-generation agriculture, research and development of smart agriculture utilizing ICT (Information and Communication Technology) and IoT (Internet of Things) is under way. Research and development is also directed to the automation and unmanned use of tractors or other work vehicles to be used in the field. For example, work vehicles which travel via automatic steering by utilizing a positioning system that is capable of precise positioning, e.g., a GNSS (Global Navigation Satellite System), are coming into practical use.

International Publication No. 2022/107586 describes a work vehicle that is capable of autonomous movement among a plurality of rows of trees in an orchard, such as a vineyard, by using an SLAM (Simultaneous Localization and Mapping) technique that simultaneously performs localization and map generation. International Publication No. 2022/107586 describes, in an orchard, a work vehicle traveling among a plurality of rows of trees, where the work vehicle performs mowing, preventive pest control, or other work by using an implement (agricultural implement) that is linked to the work vehicle.

### SUMMARY OF THE INVENTION

There is also a need for automation and unmanned application of work that is performed while a work vehicle travels in a field (e.g., an orchard). Work that is performed during the travel of a work vehicle in a field may involve the same task being iteratively performed multiple times. For example, tasks such as mowing and preventive pest control may be iteratively performed multiple times for the same field. When the same task is iteratively performed, the work vehicle performs the same task while traveling along the same path in the field in the same way. In such a case, performing every instance of autonomous travel by, e.g., a SLAM technique will lead to an unwanted increase in the processing load for the autonomous travel.

Efficiently performing iterative operations of a work vehicle is required not only in agricultural machines, but also in work vehicles that are for non-agricultural uses, such as construction vehicles or snowplow vehicles. Furthermore, even in the cases of travel that does not involve work of a work vehicle, it is necessary to efficiently carry out any travel that is performed iteratively along the same path.

Example embodiments of the present invention provide travel control systems, work vehicles, and methods of travel control that enable efficient performance of iterative operations (including travel and other operations) of a work vehicle.

According to example embodiments of the present invention, solutions as described in the following Items are provided.

### Item a1

A travel control system for a work vehicle, the travel control system including a positioning device to output position data concerning a position of the work vehicle, and a controller configured or programmed to control operation of the work vehicle, operate in a recording mode to record to a storage device path data concerning a path traveled by the work vehicle, the path data including multiple pieces of waypoint data acquired based on the position data while the work vehicle is traveling, each piece of the waypoint data including information concerning the position of the work vehicle, operate in a reproducing mode to control the operation of the work vehicle while causing the work vehicle to travel via self-driving based on the path data, classify, based on the path data, the path into a first section having a curvature that is equal to or less than a threshold and a second section having a curvature that is greater than the threshold, and vary a control method for operation of the work vehicle in the reproducing mode between the first section and the second section.

### Item a2

The travel control system of Item a1, wherein the controller is configured or programmed to, in the reproducing mode, vary the operation of the work vehicle between when the work vehicle is traveling in the first section and when the work vehicle is traveling in the second section.

### Item a3

The travel control system of Item a2, wherein the controller is configured or programmed to, in the reproducing mode, vary a speed and/or an engine speed of the work vehicle between when the work vehicle is traveling in the first section and when the work vehicle is traveling in the second section.

### Item a4

The travel control system of Item a3, wherein the controller is configured or programmed to determine a first speed of the work vehicle and a second speed of the work vehicle, the second speed being smaller than the first speed, in the reproducing mode, cause the work vehicle to travel at the first speed while the work vehicle is traveling in the first section, and, in the reproducing mode, cause the work vehicle to travel at the second speed while the work vehicle is traveling in the second section.

### Item a5

The travel control system of Item a4, wherein the controller is configured or programmed to determine the first speed and the second speed based on a user input.

### Item a6

The travel control system of any one of Items a2 to a5, wherein the controller is configured or programmed to determine a first engine speed of the work vehicle and a second engine speed of the work vehicle, the second engine speed being smaller than the first engine speed, in the reproducing mode, cause the work vehicle to travel at the first engine speed while the work vehicle is traveling in the first section, and, in the reproducing mode, cause the work vehicle to travel at the second engine speed while the work vehicle is traveling in the second section.

### Item a7

The travel control system of Item a6, wherein the controller is configured or programmed to determine the first engine speed and the second engine speed based on a user input.

### Item a8

The travel control system of any one of Items a2 to a7, wherein the controller is configured or programmed to, in the reproducing mode, decelerate the work vehicle while the work vehicle is traveling in the first section, and, in the reproducing mode, accelerate the work vehicle while the work vehicle is traveling in the second section.

### Item a9

The travel control system of Item a8, wherein the path includes a plurality of the first sections and a plurality of the second sections by which the plurality of first sections are connected, and the controller is configured or programmed to, while the work vehicle is traveling in the first section in the reproducing mode, decelerate the work vehicle in a portion leading to the second section, and, while the work vehicle is traveling in the second section in the reproducing mode, accelerate the work vehicle in a portion leading to the first section.

### Item a10

The travel control system of any one of Items a2 to a9, wherein the work vehicle has an implement linked thereto, the work vehicle includes a linkage device to which the implement is connected, the linkage device includes a three-point hitch to adjust a height of the implement, and the controller is configured or programmed to, in the reproducing mode, vary the height of the three-point hitch between when the work vehicle is traveling in the first section and when the work vehicle is traveling in the second section.

### Item a11

The travel control system of Item a10, wherein the controller is configured or programmed to, in the reproducing mode, ensure that the height of the three-point hitch is higher while the work vehicle is traveling in the second section than while the work vehicle is traveling in the first section.

### Item a12

The travel control system of any one of Items a2 to a11, wherein the work vehicle has an implement linked thereto, the work vehicle includes a linkage device to which the implement is connected, the linkage device includes a PTO shaft to supply motive power to the implement, and the controller is configured or programmed to, in the reproducing mode, switch rotation of the PTO shaft ON or OFF between when the work vehicle is traveling in the first section and when the work vehicle is traveling in the second section.

### Item a13

The travel control system of Item a12, wherein the controller is configured or programmed to, in the reproducing mode, turn rotation of the PTO shaft ON while the work vehicle is traveling in the first section, and, in the reproducing mode, turn rotation of the PTO shaft OFF while the work vehicle is traveling in the second section.

### Item a14

The travel control system of any one of Items a1 to a13, wherein the controller is configured or programmed to, when a manipulation for causing the work vehicle to begin traveling in the reproducing mode is performed by a user, compare, against a predetermined value, a difference between a position of the work vehicle assumed when the manipulation is performed and a position of a reference start point in the path data at which referencing is to begin with the manipulation, cause the work vehicle to begin traveling if the difference is equal to or less than the predetermined value, not allow the work vehicle to begin traveling if the difference is greater than the predetermined value, and ensure that the predetermined value is smaller when the reference start point is included in the second section than when the reference start point is included in the first section.

### Item a15

The travel control system of any one of Items a1 to a14, wherein the controller is configured or programmed to, when a manipulation for causing the work vehicle to begin traveling in the reproducing mode is performed by a user, compare, against a predetermined value, a difference between an azimuth of the work vehicle assumed when the manipulation is performed and an azimuth of a reference start point in the path data at which referencing is to begin with the manipulation, cause the work vehicle to begin traveling if the difference is equal to or less than the predetermined value, not allow the work vehicle to begin traveling if the difference is greater than the predetermined value, and ensure that the predetermined value is smaller when the reference start point is included in the second section than when the reference start point is included in the first section.

### Item a16

The travel control system of any one of Items a1 to a15, wherein the controller is configured or programmed to record, to the storage device, other path data concerning another path that is generated by editing the path data that is recorded in the storage device, and, when a manipulation for beginning editing of the path data is performed by a user, permit editing of the path data to be begun if an edit start point is included in the first section, and prohibit editing of the path data from beginning if the edit start point is included in the second section.

### Item a17

The travel control system of any one of Items a1 to a16, wherein the path includes a path of traveling in a field, the first section includes a plurality of parallel main paths, and the second section includes a plurality of turning paths by which the plurality of main paths are connected.

### Item a18

A work vehicle including a travel control system of any one of Items a1 to a17, a travel device including a wheel responsible for steering, and a driver to drive the travel device, wherein, in the reproducing mode, the controller is configured or programmed to cause the work vehicle to travel via self-driving by controlling the driver based on the multiple pieces of the waypoint data included in the path data.

### Item a19

A method of travel control for a work vehicle to be executed by a controller configured or programmed to control operation of a work vehicle and to operate in a recording mode and a reproducing mode, the method including, in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle, in the reproducing mode, controlling the operation of the work vehicle while causing the work vehicle to travel via self-driving based on the path data, classifying, based on the path data, the path into a first section having a curvature that is equal to or less than a threshold and a second section having a curvature that is greater than the threshold, and varying a control method for operation of the work vehicle in the reproducing mode between the first section and the second section.

### Item a20

A non-transitory computer-readable medium including a computer program to be executed by a processor in a controller configured or programmed to control operation of a work vehicle and operate in a recording mode and a reproducing mode, the computer program being executable to cause the processor to perform, in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle, in the reproducing mode, controlling the operation of the work vehicle while causing the work vehicle to travel via self-driving based on the path data, classifying, based on the path data, the path into a first section having a curvature that is equal to or less than a threshold and a second section having a curvature that is greater than the threshold, and varying a control method for operation of the work vehicle in the reproducing mode between the first section and the second section.

### Item b1

A travel control system for a work vehicle, the travel control system including a positioning device to output position data concerning a position of the work vehicle, and a controller configured or programmed to control operation of the work vehicle, operate in a recording mode to record to a storage device path data concerning a path traveled by the work vehicle, the path data including multiple pieces of waypoint data acquired based on the position data while the work vehicle is traveling, each piece of the waypoint data including information concerning the position of the work vehicle, operate in a reproducing mode to control the operation of the work vehicle while causing the work vehicle to travel via self-driving based on the path data, select three pieces of the waypoint data including any one of the multiple pieces of the waypoint data and two other pieces of the waypoint data being located on both sides of the one piece of the waypoint data and each being in a position that is a predetermined distance or greater away from the position of the one piece of the waypoint data, determine a circle defined by positions of three points that are based on the three pieces of the waypoint data, and classify, based on a radius of the circle, the path into a first section having a radius of curvature that is equal to or greater than a threshold and a second section having a radius of curvature that is less than the threshold.

### Item b2

The travel control system of Item b1, wherein the controller is configured or programmed to determine a curvature of the path at the one piece of the waypoint data based on a radius of the circle, and based on the curvature determined at each point in the path, classify the path into the first section and the second section.

### Item b3

The travel control system of Item b1 or b2, wherein the predetermined distance is greater than an interval between the positions of consecutive pieces of the waypoint data among the multiple pieces of the waypoint data.

### Item b4

The travel control system of any one of Items b1 to b3, wherein the controller is configured or programmed to determine the threshold based on a user input.

### Item b5

The travel control system of any one of Items b1 to b4, wherein the controller is configured or programmed to determine the predetermined distance based on a user input.

### Item b6

The travel control system of any one of Items b1 to b5, wherein the controller is configured or programmed to cause a display to indicate a graphical user interface (GUI) to allow a user to set the threshold and the predetermined distance.

### Item b7

The travel control system of Item b6, wherein the controller is configured or programmed to, based on the threshold and the predetermined distance that are input via the GUI, cause the display to further indicate an image indicating a result of classifying the path into the first section and the second section.

### Item b8

The travel control system of Item b7, wherein the controller is configured or programmed to, when the threshold /d/ or the predetermined distance that are input via the GUI are changed, change the image to an image indicating a result of classifying the path into the first section and the second section as based on the changed threshold and/or predetermined distance.

### Item b9

The travel control system of any one of Items b1 to b8, wherein the controller is configured or programmed to vary a control method for operation of the work vehicle in the reproducing mode between the first section and the second section.

### Item b10

A work vehicle including the travel control system of any one of Items b1 to b9, a travel device including wheels responsible for steering, and a first driver to drive the travel device, wherein, in the reproducing mode, the controller is configured or programmed to cause the work vehicle to travel via self-driving by controlling the driver based on the multiple pieces of the waypoint data included in the path data.

### Item b11

A method of travel control for a work vehicle to be executed by a controller configured or programmed to control operation of a work vehicle and operate in a recording mode and a reproducing mode, the method including, in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle, in the reproducing mode, controlling the operation of the work vehicle while causing the work vehicle to travel via self-driving based on the path data, selecting three pieces of the waypoint data including any one of the multiple pieces of the waypoint data, and two other pieces of the waypoint data being located on both sides of the one piece of the waypoint data and each being in a position that is a predetermined distance or greater away from the position of the one piece of the waypoint data, determining a circle defined by positions of three points that are based on the three pieces of the waypoint data, and classifying, based on a radius of the circle, the path into a first section having a radius of curvature that is equal to or greater than a threshold and a second section having a radius of curvature that is less than the threshold.

### Item b12

A non-transitory computer-readable medium including a computer program to be executed by a processor in a controller configured or programmed to control operation of a work vehicle and operate in a recording mode and a reproducing mode, the computer program being executable to cause the processor to perform, in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle, in the reproducing mode, controlling the operation of the work vehicle while causing the work vehicle to travel via self-driving based on the path data, selecting three pieces of the waypoint data including any one of the multiple pieces of the waypoint data, and two other pieces of the waypoint data being located on both sides of the one piece of the waypoint data and each being in a position that is a predetermined distance or greater away from the position of the one piece of the waypoint data, determining a circle defined by positions of three points that are based on the three pieces of the waypoint data, and classifying, based on a radius of the circle, the path into a first section having a radius of curvature that is equal to or greater than a threshold and a second section having a radius of curvature that is less than the threshold.

### Item c1

A controller configured or programmed to perform the method of travel control of Item a19 or b11.

### Item c2

A non-transitory computer-readable medium including a computer program to be executed by a computer configured or programmed to control operation of a work vehicle, wherein the computer program is executable to cause the computer to perform the method of travel control of Item a19 or b11.

### Item c3

A travel control system for a work vehicle, the travel control system including a positioning device to output position data concerning a position of the work vehicle, and the controller of Item c1.

### Item c4

A controller configured or programmed to control operation of a work vehicle, operate in a recording mode to record to a storage device path data concerning a path traveled by the work vehicle, the path data including multiple pieces of waypoint data acquired based on position data of the work vehicle while the work vehicle is traveling, each piece of the waypoint data including information concerning the position of the work vehicle, operate in a reproducing mode to control the operation of the work vehicle while causing the work vehicle to travel via self-driving based on the path data, classify, based on the path data, the path into a first section having a curvature that is equal to or less than a threshold and a second section having a curvature that is greater than the threshold, and vary a control method for operation of the work vehicle in the reproducing mode between the first section and the second section.

### Item c5

A controller configured or programmed to control operation of a work vehicle, operate in a recording mode to record to a storage device path data concerning a path traveled by the work vehicle, the path data including multiple pieces of waypoint data acquired based on position data of the work vehicle while the work vehicle is traveling, each piece of the waypoint data including information concerning the position of the work vehicle, operate in a reproducing mode to control the operation of the work vehicle while causing the work vehicle to travel via self-driving based on the path data, select three pieces of the waypoint data including any one of the multiple pieces of the waypoint data, and two other pieces of the waypoint data being located on both sides of the one piece of the waypoint data and each being in a position that is a predetermined distance or greater away from the position of the one piece of the waypoint data, determine a circle defined by positions of three points that are based on the three pieces of the waypoint data, and classify, based on a radius of the circle, the path into a first section having a radius of curvature that is equal to or greater than a threshold and a second section having a radius of curvature that is less than the threshold.

### Item c6

A travel control system for a work vehicle, the travel control system including a positioning device to output position data concerning a position of the work vehicle, and the controller of c4 or c5.

### Item c7

A controller including one or more processors, and one or more memories storing a computer program executable to cause the one or more processors to perform the method of travel control of Item a19 or b11.

### Item c8

A travel control system including the controller of Item c7, and a first driver to drive a travel device of the work vehicle, and in the reproducing mode, the controller is configured or programmed to cause the work vehicle to travel via self-driving by controlling the first driver based on the position data recorded in the storage device.

Example embodiments of the present invention may be implemented using devices, systems, methods, integrated circuits, computer programs, non-transitory computer-readable storage media, or any combination thereof. The computer-readable storage media may be inclusive of volatile storage media, or non-volatile storage media. The device may include a plurality of devices. In the case where the device includes two or more devices, the two or more devices may be provided within a single apparatus, or divided over two or more separate apparatuses.

According to example embodiments of the present invention, travel control systems, work vehicles, and methods of travel control that enable efficient performance of iterative operations (including travel and other operations) of work vehicles are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically showing an example of a work vehicle according to an example embodiment of the present invention.

FIG. 2 is a block diagram schematically showing an example configuration for a work vehicle and an implement according to an example embodiment of the present invention.

FIG. 3A is a block diagram showing a schematic example configuration for a travel control system according to an example embodiment of the present invention.

FIG. 3B is a block diagram showing an example configuration for a controller included in a travel control system according to an example embodiment of the present invention.

FIG. 4 is a schematic diagram showing an example configuration for a travel control system according to an example embodiment of the present invention.

FIG. 5 is a diagram schematically showing an example environment to be traveled by a work vehicle according to an example embodiment of the present invention.

FIG. 6A is a diagram schematically showing an example of a path to be traveled by a work vehicle according to an example embodiment of the present invention in a recording mode.

FIG. 6B is a diagram schematically showing a path to be traveled by a work vehicle according to an example embodiment of the present invention in a reproducing mode.

FIG. 7 is a diagram schematically showing another example of a path to be traveled by a work vehicle according to an example embodiment of the present invention.

FIG. 8 is a diagram schematically showing another example of a path to be traveled by a work vehicle according to an example embodiment of the present invention.

FIG. 9A is a flowchart showing an example processing to be performed by the controller in the recording mode.

FIG. 9B is a flowchart showing another example processing to be performed by the controller in the recording mode.

FIG. 9C is a flowchart showing still another example processing to be performed by the controller in the recording mode

FIG. 10 is a diagram showing an example of waypoint data.

FIG. 11 is a flowchart showing an example processing to be performed by the controller in the reproducing mode.

FIG. 12A is a diagram schematically showing an example processing to be performed by a controller of a travel control system according to an example embodiment of the present invention.

FIG. 12B is a diagram schematically showing an example processing to be performed by a controller of a travel control system according to an example embodiment of the present invention.

FIG. 12C is a diagram schematically showing an example processing to be performed by a controller of a travel control system according to an example embodiment of the present invention.

FIG. 13 is a diagram showing an example of operation switches and an operation terminal provided in a cabin that is included in a work vehicle.

FIG. 14 is a flowchart showing an example processing to be performed by the controller.

FIG. 15A is a diagram schematically showing an example processing to be performed by the controller.

FIG. 15B is a diagram schematically showing an example processing to be performed by the controller.

FIG. 16A is a flowchart showing an example processing to be performed by the controller in the reproducing mode.

FIG. 16B shows an example of a screen image to be displayed on a terminal device that is operated by a user who performs manipulations under the reproducing mode.

FIG. 17 is a schematic diagram for describing an example processing that is performed by the controller.

FIG. 18A is a schematic diagram for describing an example processing that is performed by the controller.

FIG. 18B is a flowchart showing an example processing to be performed by the controller when a manipulation for beginning the reproducing mode is made.

FIG. 19A is a schematic diagram for describing an example processing that is performed by the controller.

FIG. 19B is a schematic diagram for describing an example processing that is performed by the controller.

FIG. 19C is a flowchart showing an example processing to be performed by the controller.

FIG. 20 is a flowchart showing an example processing to be performed by the controller.

FIG. 21A is a schematic diagram for describing an example method of classifying a path into first sections and second sections.

FIG. 21B is a schematic diagram for describing an example method of classifying a path into first sections and second sections.

FIG. 21C is a schematic diagram for describing an example method of classifying a path into first sections and second sections.

FIG. 21D is a schematic diagram for describing an example method of classifying a path into first sections and second sections.

FIG. 22A is a diagram showing an example result of classifying a path into first sections and second sections.

FIG. 22B is a diagram showing an example result of classifying a path into first sections and second sections.

FIG. 23A shows an example of a screen image to be displayed on a terminal device that is operated by a user who performs manipulations under the reproducing mode.

FIG. 23B shows an example of a screen image to be displayed on a terminal device that is operated by a user who performs manipulations under the reproducing mode.

### DETAILED DESCRIPTION OF THE EXAMPLE EMBODIMENTS

In the present specification, a “work vehicle” means a vehicle for use in performing work in a work area. A “work area” is any place where work may be performed, e.g., a field, a mountain forest, or a construction site. A “field” is any place where agricultural work may be performed, e.g., an orchard, an agricultural field, a paddy field, a cereal farm, or a pasture. A work vehicle can be an agricultural machine such as a tractor, a rice transplanter, a combine, a vehicle for crop management, or a riding mower, or a vehicle for non-agricultural purposes such as a construction vehicle or a snowplow vehicle. A work vehicle may be configured so that an implement (also referred to as a “task device” or a “task apparatus”) that is suitable for the content of work can be attached to at least one of its front and its rear. In particular, an implement that is attached to an agricultural tractor may be referred to as an “agricultural implement”. Traveling of a work vehicle that occurs while the work vehicle performs work by using an implement may be referred to as “tasked travel”. The “operation” of a work vehicle includes not only travel of the work vehicle but also other operations.

“Self-driving” means controlling the travel of a vehicle based on the action of a controller, rather than through manual operation of a driver. During self-driving, not only the travel of the vehicle, but also the task operation (e.g., the operation of the implement) may also be automatically controlled. A vehicle that is traveling via self-driving is said to be “self-traveling”. The controller may be configured or programmed to control at least one of steering, adjustment of traveling speed, and starting and stopping of travel as are necessary for the travel of vehicle. In the case of controlling a work vehicle having an implement attached thereto, the controller may be configured or programmed to control operations such as raising or lowering of the implement, starting and stopping of the operation of the implement, and the like. Travel via self-driving includes not only the travel of a vehicle toward a destination along a predetermined path, but also the travel of merely following a target of tracking. A vehicle performing self-driving may operate not only in a self-driving mode but also in a manual driving mode of traveling through manual operation of the driver. Traveling through manual operation of the driver is referred to as “manual traveling”. “Manual operation of a driver” includes not only manual operation by a driver on the vehicle, but also remote manipulation by a driver (operator) outside the vehicle. A vehicle performing self-driving may travel partly based on manual operation of the driver. The steering of a vehicle that is based on the action of a controller, rather than manual operation of the driver, is referred to as “automatic steering”. A portion or an entirety of the controller may be external to the vehicle. Between the vehicle and a controller that is external to the vehicle, communication of control signals, commands, data, or the like may be performed. A vehicle performing self-driving may autonomously travel while sensing the surrounding environment, without any person being involved in the control of the travel of the vehicle. A vehicle that is capable of autonomous travel can travel in an unmanned manner. During autonomous travel, detection of obstacles and avoidance of obstacles may be performed.

A “crop row” is a row of agricultural items, trees, or other plants that may grow in rows on a field, e.g., an orchard or an agricultural field, or in a forest or the like. In the present specification, a “crop row” encompasses a “row of trees”.

Hereinafter, example embodiments of the present invention will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand example embodiments of the present invention, are not intended to limit the scope of claims. In the following description, component elements having identical or similar functions are denoted by identical reference numerals.

The following example embodiments are only exemplary, and the techniques according to example embodiments of the present invention are not limited to the following preferred example embodiments. For example, numerical values, shapes, materials, steps, orders of steps, etc., that are indicated in the following example embodiments are only exemplary, and admit of various modifications so long as it makes technological sense. Any one example embodiment may be combined with another.

Hereinafter, as one example, an example embodiment where the work vehicle is a tractor for use in agricultural work in a field such as an orchard will be described. Without being limited to tractors, the techniques according to example embodiments of the present invention is also applicable to other type of agricultural machines such as a rice transplanter, a combine, a vehicle for crop management, or a riding lawn mower, for example. The techniques according to example embodiments of the present invention are also applicable to vehicles for non-agricultural purposes such as a construction vehicle or a snowplow vehicle. Furthermore, the techniques according to example embodiments of the present invention is applicable to travel of a work vehicle other than in work areas, and also to travel that does not involve any work by the work vehicle.

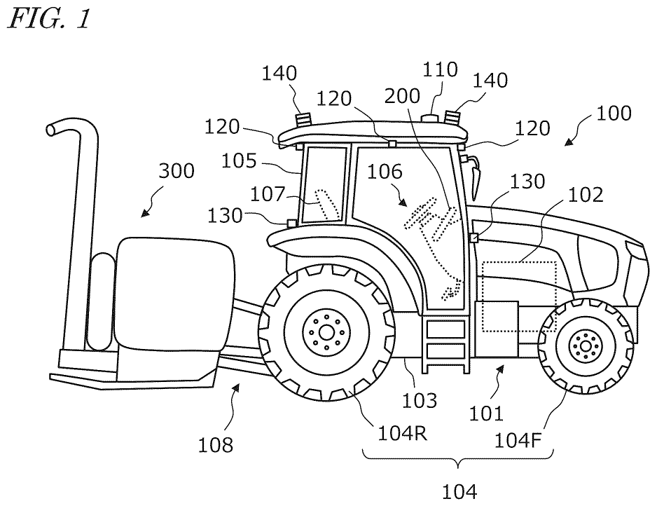

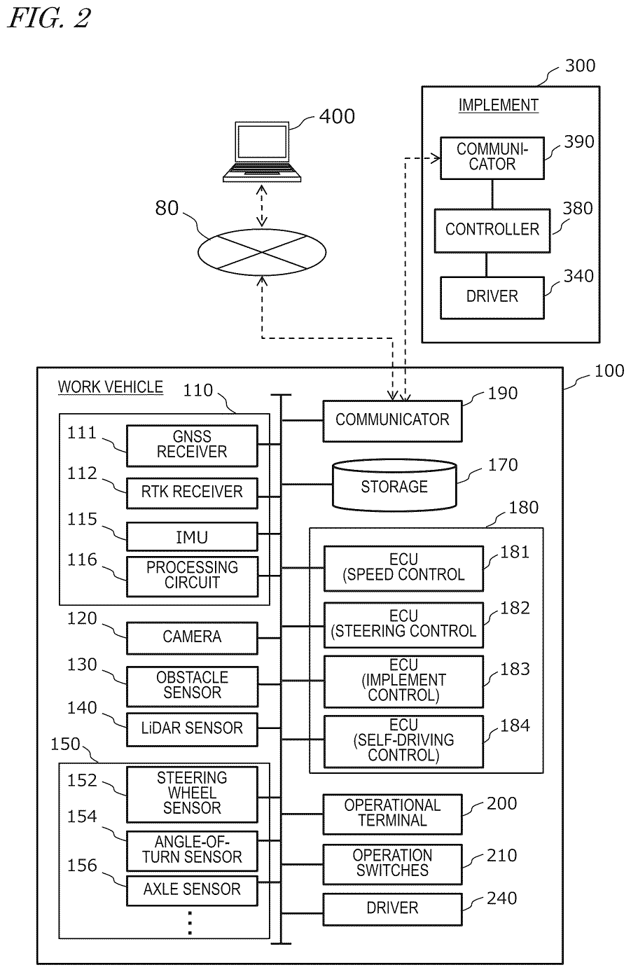

FIG. 1 is a side view schematically showing an example of a work vehicle 100 and an implement 300 that is linked to the work vehicle 100. FIG. 2 is a block diagram schematically showing an example configuration for the work vehicle 100 and the implement 300.

As shown in in FIG. 1 and FIG. 2, the work vehicle 100 includes a positioning device 110 to output position data concerning the position of the work vehicle 100 (e.g., a GNSS unit), and a controller 180 configured or programmed to control the operation of the work vehicle 100.

The work vehicle 100 may further include a sensor group 150 to output sensor data concerning the state of the work vehicle 100. The sensor group 150 includes one or more internal sensors. An “internal sensor” is inclusive of a variety of sensors that detect the state of the work vehicle 100.

The work vehicle 100 may further include a plurality of external sensors to sense the surroundings of the work vehicle 100. An “external sensor” is a sensor that senses the external state of the work vehicle. In the example of FIG. 1, the external sensors include a plurality of LiDAR sensors 140, a plurality of cameras 120, and a plurality of

### Obstacle Sensors 130.

In addition to the positioning device 110, the cameras 120, the obstacle sensors 130, and the LiDAR sensors 140, the sensor group 150, a storage device 170, the controller 180, and an operation terminal 200, the work vehicle 100 in the example of FIG. 2 also includes a communicator 190, operation switches 210, and a driver 240 (which may be referred to as a “first driver”). These component elements are communicably connected to one another via a bus.

As shown in FIG. 1, the work vehicle 100 includes a vehicle body 101, a prime mover (engine) 102, and a transmission 103. On the vehicle body 101, a travel device, which includes wheels 104 with tires, and a cabin 105 are provided. The travel device includes four wheels 104, and axles to cause the four wheels to rotate, and braking device (brakes) to brake on each axle. The wheels 104 include a pair of front wheels 104F and a pair of rear wheels 104R. Inside the cabin 105, a driver's seat 107, a steering device 106, an operation terminal 200, and switches for manipulation are provided. The front wheels 104F and/or the rear wheels 104R may be replaced by a plurality of wheels with a track (crawlers), rather than wheels with tires, attached thereto.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of the controller included in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point hitch” or a “three-point link”), a PTO (Power Take Off) shaft, a universal joint, and a communication cable. The linkage device 108 allows the implement 300 to be attached to, or detached from, the work vehicle 100. The linkage device 108 is able to raise or lower the three-point hitch with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 1 is a sprayer to spray a chemical agent onto a crop, the implement 300 is not limited to a sprayer. For example, any arbitrary task device such as a mower, a seeder, a spreader, a rake, a baler, a harvester, a plow, a harrow, or a rotary tiller may be connected to the work vehicle 100 for use.

The positioning device 110 receives satellite signals (also referred to as GNSS signals) that are transmitted from a plurality of GNSS satellites, and performs positioning based on the satellite signals. GNSS is a collective term for satellite positioning systems such as the GPS (Global Positioning System), QZSS (Quasi-Zenith Satellite System, e.g., MICHIBIKI), GLONASS, Galileo, and BeiDou. Although the positioning device 110 in the present example embodiment is located above the cabin 105, it may be located at any other position.

As shown in FIG. 2, the positioning device 110 includes a GNSS receiver 111, an RTK receiver 112, and a processing circuit 116. The positioning device 110 may further include an inertial measurement unit (IMU) 115.

The GNSS receiver 111 includes an antenna to receive signals from the GNSS satellites, and a processing circuit to determine the position of the work vehicle 100 based on the signals received by the antenna. The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received.

The positioning device 110 may perform positioning of the work vehicle 100 by utilizing an RTK (Real Time Kinematic)-GNSS. In the positioning based on the RTK-GNSS, not only satellite signals transmitted from a plurality of GNSS satellites, but also a correction signal that is transmitted from a reference station is used. The reference station may be located near the work area where the work vehicle 100 performs tasked travel (e.g., at a position within 10 km of the work vehicle 100). The reference station generates a correction signal of, for example, an RTCM format based on the satellite signals received from the plurality of GNSS satellites, and transmits the correction signal to the positioning device 110. The RTK receiver 112, which includes an antenna and a modem, receives the correction signal transmitted from the reference station. Based on the correction signal, the processing circuit 116 of the positioning device 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The positioning device 110 calculates the position of the work vehicle 100 as frequently as, for example, one to ten times per second. Note that the positioning method is not limited to being performed by using an RTK-GNSS, and any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The positioning device 110 according to the present example embodiment may further include the IMU 115. With the inclusion of the IMU 115, the positioning device 110 can complement position data by utilizing signals from the IMU. The data acquired by the IMU 115 can be used to complement the position data based on the satellite signals, so as to improve the performance of positioning.

The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. For example, the IMU 115 outputs a signal as frequently as approximately several ten times to several thousand times per second. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

The sensor group 150 may include various sensors to detect the state of the work vehicle 100 or the implement 300 (i.e., interior sensors). For example, the sensor group 150 may include a steering wheel sensor 152, an angle-of-turn sensor 154, and an axle sensor 156.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 may be used for steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100. Measurement values from the axle sensor 156 can be utilized for the speed control by the controller 180.

The storage device 170 includes one or more storage media such as a flash memory or a magnetic disc. The storage device 170 stores various data that is generated by the positioning device 110, the cameras 120, the obstacle sensors 130, and the LiDAR sensors 140, the sensor group 150, and the controller 180. The data that is stored by the storage device 170 may include an environment map of the environment where the work vehicle 100 travels, an obstacle map that is consecutively generated during travel, and path data for self-driving. The storage device 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs include, for example, the ECU 181 for speed control, the ECU 182 for steering control, the ECU 183 for implement control, and the ECU 184 for self-driving control.

The ECU 181 is configured or programmed to control the prime mover 102, the transmission 103, and brakes included in the driver 240, thus controlling the speed of the work vehicle 100.

The ECU 182 is configured or programmed to control the hydraulic device or the electric motor included in the steering device 106 based on a measurement value of the steering wheel sensor 152, thus controlling the steering of the work vehicle 100.

In order to cause the implement 300 to perform a desired operation, the ECU 183 is configured or programmed to control the operations of the three-point hitch, the PTO shaft, and the like that are included in the linkage device 108. Also, the ECU 183 is configured or programmed to generate a signal to control the operation of the implement 300, and transmits this signal from the communicator 190 to the implement 300.

Based on data output from the positioning device 110, the cameras 120, the obstacle sensors 130, and the LiDAR sensors 140, and the sensor group 150, the ECU 184 is configured or programmed to perform computation and control for achieving self-driving. For example, the ECU 184 is configured or programmed to estimate the position of the work vehicle 100 based on the data output from at least one of the positioning device 110, the cameras 120, and the LiDAR sensors 140. In a situation where a sufficiently high reception intensity exists for the satellite signals from the GNSS satellites, the ECU 184 may be configured or programmed to determine the position of the work vehicle 100 based only on the data output from the positioning device 110. On the other hand, in an environment where obstructions, such as trees, that may hinder reception of the satellite signals exist around the work vehicle 100, e.g., an orchard, the ECU 184 estimates the position of the work vehicle 100 by using the data output from the LiDAR sensors 140 or the cameras 120. During self-driving, the ECU 184 performs computation necessary for the work vehicle 100 to travel along a target path, based on the estimated position of the work vehicle 100. The ECU 184 is configured or programmed to send the ECU 181 a command to change the speed, and send the ECU 182 a command to change the steering angle. In response to the command to change the speed, the ECU 181 is configured or programmed to control the prime mover 102, the transmission 103, or the brakes to change the speed of the work vehicle 100. In response to the command to change the steering angle, the ECU 182 is configured or programmed to control the steering device 106 to change the steering angle.

Through the actions of these ECUs, the controller 180 is configured or programmed to realize self-traveling. During self-traveling, the controller 180 is configured or programmed to control the driver 240 based on the measured or estimated position of the work vehicle 100 and on the consecutively-generated target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 184 are illustrated as individual blocks in FIG. 2, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes a processing circuit including one or more processors.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device, which is responsible for remote monitoring, for example. The images may be used to monitor the work vehicle 100 during unmanned driving. The cameras 120 may be provided according to the needs, and any number of them may be provided.

The LiDAR sensors 140 are one example of external sensors that output sensor data indicating a distribution of geographic features around the work vehicle 100. In the example of FIG. 1, two LiDAR sensors 140 are located on the cabin 105, at the front and the rear. The LiDAR sensors 140 may be provided at other positions (e.g., on a lower portion of a front face of the vehicle body 101). While the work vehicle 100 is traveling, each LiDAR sensor 140 repeatedly outputs sensor data representing the distances and directions of measurement points on objects existing in the surrounding environment, or two-dimensional or three-dimensional coordinate values of such measurement points. The number of LiDAR sensors 140 is not limited to two, but may be one, or three or more.

The LiDAR sensors 140 may be configured to output two-dimensional or three-dimensional point cloud data as sensor data. In the present specification, “point cloud data” broadly means data indicating a distribution of multiple reflection points that are observed with the LiDAR sensors 140. The point cloud data may include coordinate values of each reflection point in a two-dimensional space or a three-dimensional space or information indicating the distance and direction of each reflection point, for example. The point cloud data may include information of luminance of each reflection point. The LiDAR sensors 140 may be configured to repeatedly output point cloud data with a pre-designated cycle, for example. Thus, the external sensors may include one or more LiDAR sensors 140 that output point cloud data as sensor data.

The sensor data that is output from the LiDAR sensors 140 is processed by a controller configured or programmed to control self-traveling of the work vehicle 100. During travel of the work vehicle 100, based on the sensor data that is output from the LiDAR sensors 140, the controller can consecutively generate an obstacle map indicating a distribution of objects existing around the work vehicle 100. The controller may be configured or programmed to generate an environment map by joining together obstacle maps with the use of an algorithm such as SLAM, for example, during self-traveling. The controller can be configured or programmed to perform estimation of the position and orientation of the work vehicle 100 (i.e., localization) by matching the sensor data against

### The Environment Map.

The plurality of obstacle sensors 130 shown in FIG. 1 are provided at the front and the rear of the cabin 105. The obstacle sensors 130 may be located at other positions. For example, one or more obstacle sensors 130 may be located at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles.

The controller of the work vehicle 100 may be configured or programmed to utilize, for positioning, the sensor data acquired with the sensing devices such as the cameras 120 or the LIDAR sensors 140, in addition to the results of positioning provided by the positioning device 110. In the case where geographic features serving as characteristic points exist in the environment that is traveled by the work vehicle 100, as in the case of an agricultural road, a forest road, a general road, or an orchard, the position and the orientation of the work vehicle 100 can be estimated with a high accuracy based on data that is acquired with the cameras 120 or the LiDAR sensors 140 and on an environment map that is previously stored in the storage device. By correcting or complementing position data based on the satellite signals using the data acquired with the cameras 120 or the LiDAR sensors 140, it becomes possible to identify the position of the work vehicle 100 with a higher accuracy.

The work vehicle 100 and the implement 300 can communicate with each other via a communication cable that is included in the linkage device 108. The work vehicle 100 is able to communicate with a terminal device 400 for remote monitoring via a network 80. The terminal device 400 may be any arbitrary computer, e.g., a personal computer (PC), a laptop computer, a tablet computer, or a smartphone, for example.

The implement 300 includes a driver 340 (which may be referred to as the “second driver”), a driver 340, a controller 380, and a communicator 390. Note that FIG. 2 shows component elements which are relatively closely related to the operations of self-driving by the work vehicle 100, while other components are omitted from illustration.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 1, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as a camera(s) for generating images for monitoring purposes. The infrared camera(s) may also be used for detection of obstacles at nighttime.

An obstacle sensor 130 detects objects around the work vehicle 100. The obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be located at different positions of the work vehicle 100. Providing a multitude of obstacle sensors 130 can reduce blind spots in monitoring obstacles around the work vehicle 100.

The driver 240 includes various types of devices required to cause the work vehicle 100 to travel and to drive the implement 300, for example, the prime mover 102, the transmission 103, the steering device 106, the linkage device 108 and the like described above. The prime mover 102 may include an internal combustion engine such as, for example, a diesel engine. The driver 240 may include an electric motor for traction instead of, or in addition to, the internal combustion engine.

The communicator 190 is a device including a circuit to communicate with the implement 300 and the terminal device 400. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with the terminal device 400. The network 80 may include a 3G, 4G, 5G, or any other cellular mobile communications network and the Internet, for example. The communicator 190 may have a function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operation terminal 200 is a terminal for the user to perform a manipulation related to the travel of the work vehicle 100 and the operation of the implement 300, and is also referred to as a virtual terminal (VT). The operation terminal 200 may include a display device such as a touch screen panel, and/or one or more buttons. The display device may be a display such as a liquid crystal display or an organic light-emitting diode (OLED) display, for example. By manipulating the operation terminal 200, the user can perform various manipulations, such as, for example, switching ON/OFF the self-driving mode, switching ON/OFF a recording (teaching) mode and a reproducing (playback) mode as will be described below/, and switching ON/OFF the implement 300. At least some of these manipulations may also be realized by manipulating the operation switches 210. The operation terminal 200 may be configured so as to be detachable from the work vehicle 100. A user who is at a remote place from the work vehicle 100 may manipulate the detached operation terminal 200 to control the operation of the work vehicle 100. The operation terminal 200 may include a storage device. In place of the storage device 170, the storage device in the operation terminal 200 may store various data that is necessary for the operation of the work vehicle 100.

The driver 340 in the implement 300 shown in FIG. 2 performs necessary operations for the implement 300 to perform predetermined tasks. The driver 340 includes a device that is adapted to the use of the implement 300, e.g., a hydraulic device, an electric motor, or a pump. The controller 380 is configured or programmed to control the operation of the driver 340. In response to signals that are transmitted from the work vehicle 100 via the communicator 390, the controller 380 is configured or programmed to cause the driver 340 to perform various operations. Moreover, a signal that is in accordance with the state of the implement 300 may be transmitted from the communicator 390 to the work vehicle 100.

A travel control system according to an example embodiment of the present invention will be described. The travel control system according to the present example embodiment of the present invention is applicable to the above-described work vehicle 100, for example. Although the examples of FIG. 1 and FIG. 2 illustrate the implement 300 as being linked to the work vehicle 100, it is not essentially required for the implement 300 to be linked to the work vehicle 100. In other words, the travel control system according to the present example embodiment of the present invention is applicable also to the work vehicle 100 without the implement 300 linked thereto.

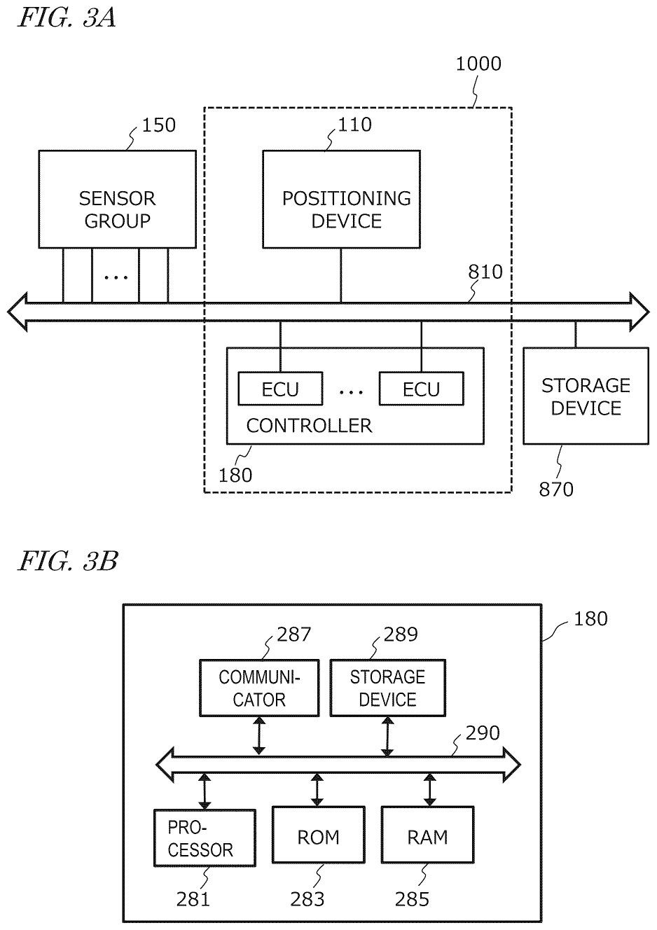

FIG. 3A is a block diagram showing a schematic example configuration for the travel control system 1000 according to the present example embodiment of the present invention. As shown in FIG. 3A, the travel control system 1000 according to the present example embodiment includes a positioning device 110 to detect the position of the work vehicle 100 and output position data, and a controller 180 to control the operation of the work vehicle 100. In the present example embodiment, as shown in FIG. 2, the positioning device 110 and the controller 180 are provided in the work vehicle 100. Working in cooperation with the positioning device 110, the controller 180 functions as the travel control system 1000 of the work vehicle 100. The controller 180 and the positioning device 110 may be communicably connected to one another via the bus 810.

FIG. 3A together shows one or more internal sensors (sensor group) 150 to output sensor data concerning the state of the work vehicle 100. The sensor group 150 may be included as portion of the travel control system 1000, or be external elements to the travel control system 1000. In the present example embodiment, as shown in FIG. 2, the sensor group 150 is provided in the work vehicle 100. The sensor group 150 may be communicably connected to the controller 180 and the positioning device 110 via the bus 810.

FIG. 3A also shows a storage device 870, to which information that is acquired by the controller 180 is recorded. The storage device 870 may be included in the travel control system 1000, or be an external element to the travel control system 1000. The storage device 870 may be mounted in the work vehicle 100, or mounted in the implement 300. The storage device 870 may be communicably connected to the controller 180 via the 810. For example, the storage device 870 may be the storage device 170 shown in FIG. 2, or a storage device that is included in the operation terminal 200. The operation terminal 200 may be included in the travel control system 1000. The storage device 870 may be located outside of the work vehicle 100 and the implement 300. When located outside of the work vehicle 100 and the implement 300, the storage device 870 may be connected to the controller 180 via a communications network.

In the example shown in FIG. 1, the positioning device 110 is mounted to the work vehicle 100. However, the positioning device 110 may be mounted to the implement 300 that is linked to the work vehicle 100. In addition to or instead of the positioning device mounted to the work vehicle 100, a positioning device (e.g., a GNSS unit) that is mounted to the implement 300 may function as a positioning device 110 of the travel control system 1000. Strictly speaking, a position that is measured by a positioning device that is mounted to the work vehicle 100 or the implement 300 is the position of a point at which the positioning device exists, but this position is referred to as the “position of the work vehicle” in the present specification.

Without being limited to the steering wheel sensor 152, the angle-of-turn sensor 154, and the axle sensor 156 mentioned above, various sensors that are mounted in the work vehicle 100 may be included in the sensor group 150. For example, the sensor group 150 may include one or more sensors selected from among a temperature sensor, an illuminance sensor, a fuel sensor, a water temperature sensor, an oil level gauge, an engine revolution sensor, a vehicle speed sensor, a battery voltage sensor, a shuttle sensor, a hand accelerator sensor, an accelerator pedal sensor, a main shift lever sensor, a range shift lever sensor, a seat belt sensor, a PM sensor, an acceleration sensor, an angular velocity sensor, an IMU (Inertial Measurement Unit), and a geomagnetic sensor. The sensor group 150 may include a PTO sensor to detect rotation ON/OFF of the PTO shaft and/or a 3P position sensor to detect the position in the height direction (which hereinafter may be simply referred to as “height”) of the three-point hitch. Furthermore, in addition to or instead of one or more sensors mounted on the work vehicle 100, one or more sensors that are mounted on the implement 300 may be included in the sensor group 150 of the travel control system 1000.

In the example shown in FIG. 3A, the controller 180 includes a plurality of ECUs. These ECUs may include the ECUs 181 to 184 illustrated in FIG. 2, for example. However, the controller 180 may be a single ECU or other computer. FIG. 3B is a block diagram showing an example configuration for such a controller 180. In the example of FIG. 3B, the controller 180 includes a processor 281, a ROM (Read Only Memory) 283, a RAM (Random Access Memory) 285, a communicator 287, and a storage device 289. These component elements may be connected to one another via a bus 290.

The processor 281 is a semiconductor integrated circuit, also called a central processing unit (CPU) or a microprocessor. The processor 281 may include a graphics processing unit (GPU). The processor 281 consecutively executes a computer program describing predetermined instructions and being stored in the ROM 283, and achieves processes that are necessary for the travel control system according to the present example embodiment of the present invention. The controller 180 may include a plurality of processors 281. The plurality of processors 281 may work in cooperation to perform the processes that are necessary for the travel control system according to the present example embodiment of the present invention. A portion or an entirety of the processor 281 may be an FPGA (Field Programmable Gate Array), an ASIC (Application Specific Integrated Circuit), or an ASSP (Application Specific Standard Product) incorporating a CPU.

The communicator 287 is an interface for performing data communications between the controller 180 and an external computer. The communicator 287 is capable of wired communications via a CAN (Controller Area Network) or the like, or wireless communications compliant with the Bluetooth (registered trademark) standards and/or the Wi-Fi (registered trademark) standards.

The storage device 289 can store position data acquired from the positioning device 110, sensor data acquired from the sensor group 150, position data and/or sensor data in the middle of processing, data of first information acquired from the position data and second information acquired from the sensor data, and the like. The storage device 289 includes a hard disk drive or a non-volatile semiconductor memory, for example. In this example, the storage device 289 may serve as the storage device 870 in the example of FIG. 3A.

The hardware configuration of the controller 180 is not limited to the above example. It is not necessary for a portion or an entirety of the controller 180 to be mounted in the work vehicle 100. By utilizing the communicator 287, a computer or computers located outside the work vehicle 100 may be allowed to function as a portion or an entirety of the controller 180. For example, a computer or computers included in a server computer(s) and/or a terminal device(s) that is connected to a network may function as a portion or an entirety of the controller 180. On the other hand, a computer or computers that is mounted in the work vehicle 100 may perform all functions required of the controller 180.

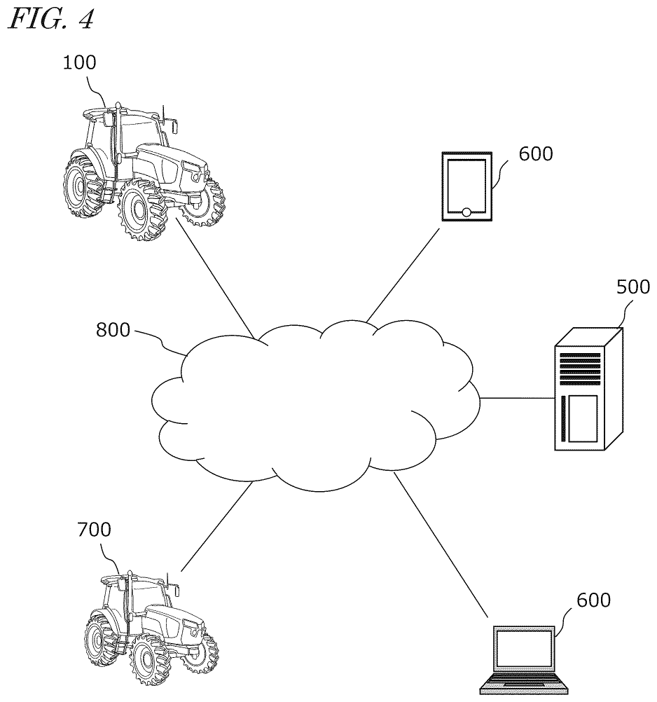

FIG. 4 is a schematic diagram showing another example configuration for a travel control system according to an example embodiment of the present invention. The system shown in FIG. 4 includes the work vehicle 100, another work vehicle 700, a server computer 500, and a plurality of terminal devices 600. The terminal devices 600 may be either mobile or stationary terminal devices. A portion or an entirety of the functionality of the controller 180 shown in FIG. 3B may be realized by one or more computers that are connected to the communicator 287 of the controller 180 of the work vehicle 100 via a communications network 800. Such a computer(s) may be the server computer 500 or the terminal device(s) 600. This communications network 800 may have the other work vehicle (e.g., agricultural machine) 700 connected thereto. Communication may be performed between the controller 180 of the work vehicle 100 and the other work vehicle 700. Via the communications network 800, a portion of the data to be used for the processing by the controller 180 of the work vehicle 100 may be supplied from the other work vehicle 700 to the controller 180. For example, waypoint data defining a path and a series of operations as generated by the controller of the other work vehicle 700 may be transmitted from the other work vehicle 700 to the controller 180 of the work vehicle 100. Based on the waypoint data, the controller 180 can perform a playback operation in a reproducing mode as will be described below.

As shown in FIG. 3B, an example of the “controller” in an example embodiment of the present invention is a computer that includes at least one processor and at least one memory storing a computer program (code) defining control processes to be executed by the processor. The “controller” may be a computer equipped with an FPGA (Field-Programmable Gate Array), an ASSP (Application Specific Standard Product), an ASIC (Application-Specific Integrated Circuit), or other hardware accelerators configured to execute the control processes.

A “processor” in an example embodiment of the present invention is a hardware electronic circuit such as a CPU (Central Processing Unit), a GPU (Graphics Processing Unit), a DSP (Digital Signal Processor), an ISP (Image Signal Processor), or an NPU (Neural Network Processing Unit). A “memory” is a hardware electronic circuit such as a ROM (Read Only Memory) or a RAM (Random Access Memory). A portion of the memory may be a storage medium that is connected to the processor via interconnects or a network. These hardware electronic circuits may be implemented by one or more integrated circuits (IC) or large-scale integrated circuits (LSI). Each functional unit or block and its associated components within the electronic circuit may be individually manufactured as an individual integrated circuit chip, or a portion or an entirety of these functional units or blocks may be combined so as to be manufactured as a single integrated circuit chip.

A program defining the operation of a processor is designed so that the processor will execute one or more functions, manipulations, steps, or process according to an example embodiment of the present invention.

As will be described below, the travel control system 1000 is capable of controlling the operation of the work vehicle 100 by using a so-called teaching-playback method, which is used in the fields of robot control. The controller 180 of the travel control system 1000 can operate in a recording mode and a reproducing mode. The recording mode is a mode in which multiple positions (hereinafter also referred to as “waypoints”) defining a travel path of the work vehicle 100 are recorded. In the recording mode, operations of the work vehicle 100 at the respective waypoints may further be recorded. The reproducing mode is a mode in which the travel path of the work vehicle 100 as recorded in the recording mode is reproduced. If operations of the work vehicle 100 at the respective waypoints were recorded in the recording mode, the operations of the work vehicle 100 at the respective waypoints may also be reproduced in the reproducing mode. The operations in the recording mode and the reproducing mode correspond to, respectively, an operation of teaching and an operation of playback in the teaching-playback method. The operations of the controller 180 in the recording mode and the reproducing mode may be referred to as “teaching” and “playback”, respectively. The recording mode may be referred to as the “teaching mode”, and the reproducing mode as the “playback mode”.

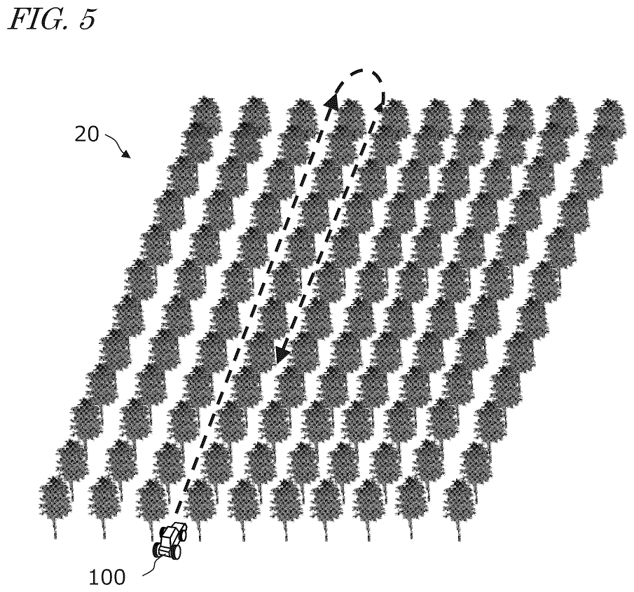

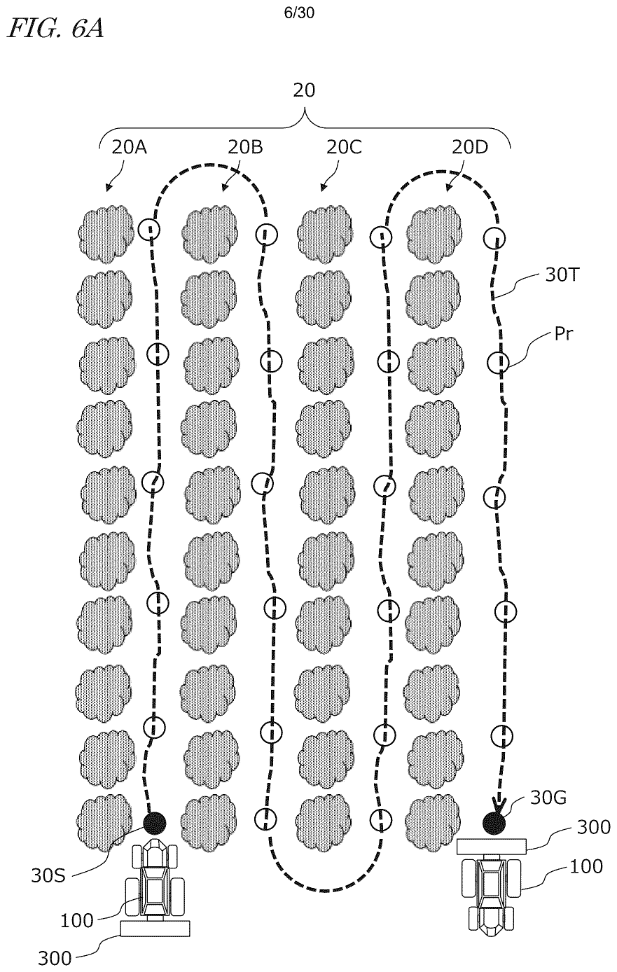

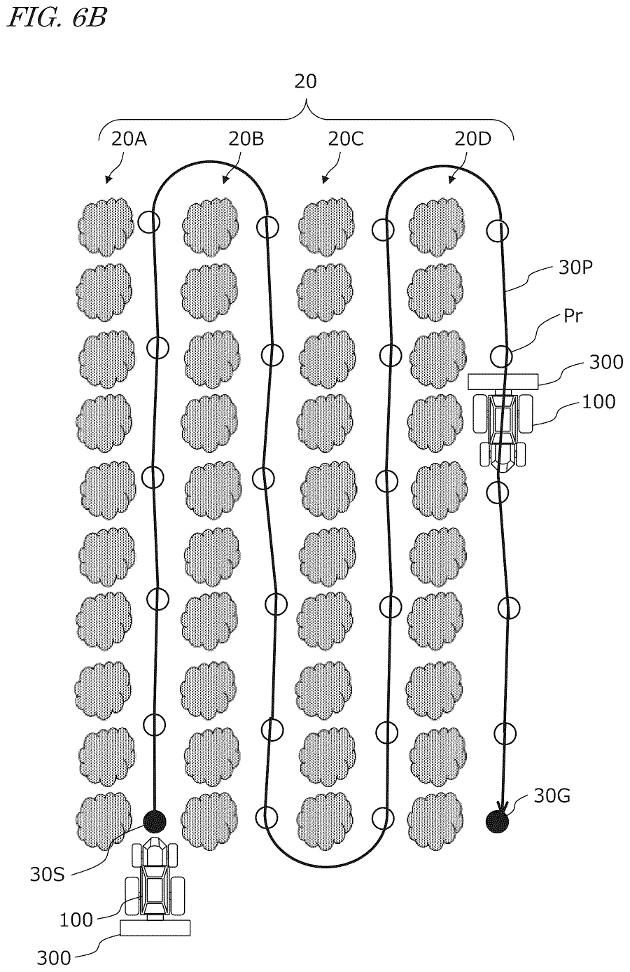

With reference to FIG. 5, FIG. 6A and FIG. 6B, operations of the controller 180 of the travel control system 1000 in the recording mode and the reproducing mode will be described. FIG. 5 is a diagram schematically showing an example of an environment in which the work vehicle 100 travels. FIG. 6A is a diagram schematically showing an example of a path 30T that is traveled by the work vehicle 100 in the recording mode. FIG. 6B is a diagram schematically showing an example of a path 30P that is traveled by the work vehicle 100 in the reproducing mode. In this example, the work vehicle 100 performs predetermined tasks (e.g., mowing, preventive pest control, seeding, manure spreading, etc.) by using the implement 300, while traveling among the plurality of rows of trees 20 (hereinafter also referred to as “crop rows 20”) in an orchard such as a vineyard.

In the recording mode, in the example of FIG. 6A, the work vehicle 100 performs travel while performing work by the implement 300. In the example of FIG. 6A, the work vehicle 100 travels along the path 30T from a start point 30S to an end point 30G. FIG. 6A illustrates a state where the work vehicle 100 is located before the start point 30S and a state where the work vehicle 100 is located at a point beyond the end point 30G. In the recording mode, while the work vehicle 100 is traveling, the controller 180 records multiple pieces of waypoint data to the storage device 870, based on position data that is output from the positioning device 110. Each of the multiple pieces of waypoint data includes first information concerning the position of the work vehicle 100. Each of the multiple pieces of waypoint data may further include second information concerning the state of the work vehicle 100. In other words, in the recording mode, while the work vehicle 100 is traveling, the controller 180 may record multiple pieces of waypoint data including first information and second information to the storage device 870 respectively based on the position data that is output from the positioning device 110 and the sensor data that is output from the sensor group 150. The first information and second information included in each piece of waypoint data indicate a position of the work vehicle 100 and the state of the work vehicle 100 at that position, respectively. Therefore, the first information may be referred to as “positional information”, and the second information may be referred to as “state information”. Multiple pieces of first information that are included in multiple pieces of waypoint data represent the path 30T that has been traveled by the work vehicle 100. The multiple pieces of waypoint data may be recorded to the storage device 870 as “path data” representing the path 30T, in association with information of the path 30T (e.g., including an identifier indicating the path 30T). Each of the multiple pieces of second information that are included in the multiple pieces of waypoint data is recorded in association with the corresponding first information. As each of the multiple pieces of second information that are included in the multiple pieces of waypoint data is recorded in association with the corresponding first information, information of the state of the work vehicle 100 at each position on the path 30T that has been traveled by the work vehicle 100 becomes recorded. For example, as shown in FIG. 6A, at each of the multiple positions (waypoints) Pr on the path 30T having been traveled, first information and second information are acquired and recorded as waypoint data.

In the recording mode, the work vehicle 100 may perform manual traveling via manual operation of the driver, or self-traveling via self-driving. When the work vehicle 100 performs self-traveling in the recording mode, the work vehicle 100 may autonomously travel without involving manual operation of the driver, or perform self-traveling but travel partly based on manual operation of the driver. For example, an automatic steering control may be performed during travel in the recording mode, such that the driver performs control of the traveling speed of the work vehicle 100 while steering control is automatically performed. Alternatively, during travel in the recording mode, the work vehicle 100 may perform self-traveling, while the implement 300 operates via manual operation of the driver. Manual operation of the driver includes not only manual operation of the driver on the work vehicle 100, but also remote operation by a driver (operator) outside the work vehicle 100. Such remote operations may be performed by using the terminal devices 600 shown in FIG. 4, or other remote operation devices, for example.

The second information broadly includes information concerning states of the work vehicle 100 other than its position. The second information includes information concerning operation of the work vehicle 100, e.g., a traveling state, for example. The traveling state of the work vehicle 100 is defined by velocity, acceleration (i.e., rate of change in velocity per unit time), traveling direction (azimuth), and the like of the work vehicle 100. Information concerning the traveling state of the work vehicle 100 includes any one or more of information of the velocity of the work vehicle 100, information of the engine speed of the work vehicle 100, information of the acceleration of the work vehicle 100, information of the azimuth of the work vehicle 100, information of the steering angle of the wheels responsible for steering of the work vehicle 100, information of the gear ratio of the transmission 103 of the work vehicle 100, and the like, for example. The second information may include information of the attitude of the work vehicle 100. Information of the attitude of the work vehicle 100 includes information of the azimuth of the work vehicle 100, for example. Without being limited to information concerning the operation of the work vehicle 100, the second information may include information of the temperature of the work vehicle 100 (e.g., temperature of the engine coolant), information concerning the presence/absence of problems of the work vehicle 100 (e.g., Diagnostic Trouble Code: DTC), and the like, for example. Specific examples of methods of acquiring the second information will be described later.

The second information may include information concerning the state of the linkage device 108 for enabling linking of the implement 300. The linkage device 108 may include the PTO shaft for supplying motive power to the implement 300 and a three-point hitch for adjusting the height of the implement 300, for example. Information concerning the state of the linkage device 108 may include any one or more of information of rotation ON or OFF of the PTO shaft, and information of the height of the three-point hitch, for example.

In a case where the work vehicle 100 has the implement 300 linked thereto, the second information may include, in addition to information concerning the state of the work vehicle 100, information concerning the state of the implement 300. For example, in a case where the implement 300 has a positioning device mounted thereto, information of the position or azimuth (e.g., angle with respect to a reference azimuth) of the implement 300 may be included in the second information. Alternatively, in a case where a sensor to detect the operation of a movable structure in the implement 300 is provided in the implement 300, information that is detected by that sensor may be included in the second information.

In the reproducing mode, the work vehicle 100 performs travel via self-driving. While causing the work vehicle 100 to perform self-traveling based on the first information included in multiple pieces of waypoint data recorded in the recording mode, the controller 180 is configured or programmed to control the operation of the work vehicle 100. In a case where each of the multiple pieces of waypoint data includes second information concerning the state of the work vehicle 100, the controller 180 is configured or programmed to control the operation of the work vehicle 100 while causing the work vehicle 100 to perform self-traveling based on the first information and second information included in the multiple pieces of waypoint data recorded in the recording mode. In the example of FIG. 6B, based on the first information (positional information) and the second information (state information) included in the multiple pieces of waypoint data recorded when traveling along the path 30T (see FIG. 6A) in the recording mode, the work vehicle 100 performs self-traveling. In the reproducing mode, the controller 180 causes the work vehicle 100 to travel along a target path 30P that is defined by the first information included in the multiple pieces of waypoint data recorded in the recording mode. For example, the controller 180 is configured or programmed to perform steering control for the work vehicle 100 so as to minimize deviations of the position and orientation (azimuth) of the work vehicle 100 with respect to the target path 30P. This allows the work vehicle 100 to travel along the target path 30P. In the reproducing mode, the work vehicle 100 is able to automatically reproduce the operation of the work vehicle 100 that was recorded in the recording mode.

The reproducing mode is begun in a state where the work vehicle 100 is located at the start point 30S of the target path 30P, for example. The reproducing mode may be begun in a state where the work vehicle 100 is located at any point midway the target path 30P (i.e., anywhere between the start point 30S and the end point 30G). As the work vehicle 100 reaches the end point 30G of the target path 30P, for example, the controller 180 ends the reproducing mode. Without being limited thereto, even when the work vehicle 100 is located at any point midway the target path 30P, the controller 180 may end self-driving under the reproducing mode upon receiving a signal including an instruction to end the reproducing mode, for example. FIG. 6B illustrates a state where the work vehicle 100 is located before the start point 30S and a state where the work vehicle 100 is located somewhere along the path 30P.

As in the examples of FIG. 6A and FIG. 6B, in a case where the work vehicle 100 has the implement 300 linked thereto, based on the first information (or, the first information and second information) included in multiple pieces of waypoint data recorded in the recording mode, the controller 180 can control the operations of the work vehicle 100 and the implement 300, while causing the work vehicle 100 to perform self-traveling. In other words, in the reproducing mode, the work vehicle 100 can automatically reproduce not only the operation of the work vehicle 100 that was recorded in the recording mode, but also the operation of the implement 300.

With the travel control system according to the present example embodiment, in the reproducing mode, it is possible to reproduce the operation of the work vehicle 100 based on the first information concerning the position of the work vehicle 100 as recorded in the recording mode. As a result, iterative operations of the work vehicle 100 can be efficiently performed. Thus, automation and unmanned execution of the operation of the work vehicle 100 are promoted. In a case where second information concerning the state of the work vehicle 100 other than its position is recorded in association with the first information concerning the position of the work vehicle 100 in the recording mode, automation and unmanned execution of the operation of the work vehicle 100 is further promoted.

In a case where the work vehicle 100 has the implement 300 linked thereto, in the reproducing mode, the operation of the work vehicle 100 having the implement 300 linked thereto can be reproduced based on the first information recorded in the recording mode. As a result, iterative operations of the implement 300 having the implement 300 linked thereto can be efficiently carried out. For example, in the recording mode, second information concerning the state of the implement 300 may be recorded in association with the first information concerning the position of the work vehicle 100, thus promoting automation and unmanned execution of the work by the implement 300. In other words, the work vehicle 100 can automatically reproduce not only the operation of the work vehicle 100 that was recorded in the recording mode, but also the operation of the implement 300. As a result, iterative work to be performed by the implement 300 can be efficiently carried out.

In the examples of FIG. 6A and FIG. 6B, the work vehicle 100 travels along the path 30T or the path 30P among the plurality of rows of trees 20. More specifically, the work vehicle 100 travels between two adjacent rows of trees 20, and turns in a headland before and after the travel between the two adjacent rows of trees 20. A headland is a region between an end of each row of trees and the boundary of the orchard. Specifically, the following operation may be performed. Let the plurality of rows of trees 20 be sequentially designated as a first row of trees 20A, a second row of trees 20B, a third row of trees 20C, a fourth row of trees 20D, . . . , from the end. From the start point 30S, the work vehicle 100 first travels between the first row of trees 20A and the second row of trees 20B, and upon completing this travel, turns right to travel between the second row of trees 20B and the third row of trees 20C in the opposite direction. Once the travel between the second row of trees 20B and the third row of trees 20C is completed, it further turns left to travel between the third row of trees 20C and the fourth row of trees 20D. Thereafter, by repeating a similar operation, the work vehicle 100 travels to the end point 30G of the path 30T or the path 30P.

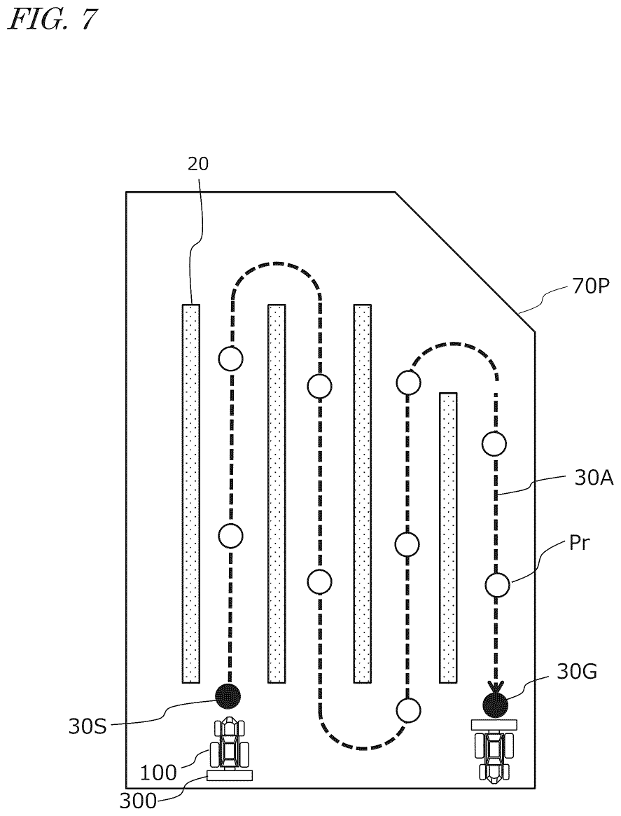

FIG. 7 and FIG. 8 are diagrams schematically showing other examples of paths that are traveled by the work vehicle 100.

FIG. 7 shows, in a non-rectangular field 70P, a path 30A along which the work vehicle 100 travels among a plurality of crop rows 20. In the recording mode, the work vehicle 100 travels along the path 30A from a start point 30S to an end point 30G. In the reproducing mode, the controller 180 causes the work vehicle 100 to perform self-traveling along a target path that is defined by the first information included in multiple pieces of waypoint data recorded in the recording mode. As shown in FIG. 7, autonomous travel may not be easy in a non-rectangular field because the crop rows 20 may differ from one another in length. By using the travel control system according to the present example embodiment, iterative operations of the work vehicle 100 can be efficiently performed even in a non-rectangular field, thus promoting automation and unmanned execution of the operation of the work vehicle 100.

FIG. 8 shows a path 30B along which the work vehicle 100 travels, outside the fields 70. The region depicted in FIG. 8 includes a number of fields 70 where the work vehicle 100 performs agricultural work, and roads 76 around the fields. The roads 76 may be agricultural roads. In the recording mode, the work vehicle 100 travels along the path 30B from a start point 30S to an end point 30G. In the reproducing mode, the controller 180 causes the work vehicle 100 to perform self-traveling along a target path that is defined by the first information included in multiple pieces of waypoint data recorded in the recording mode. As shown in FIG. 8, the travel control system according to the present example embodiment is also applicable to travel that is performed outside the fields. For example, it is suitably applicable to any manner of travel that is performed iteratively, e.g., movements of the work vehicle 100 from field to field or movements of the work vehicle 100 between its storage location and a field. In such a case, iterative operations of the work vehicle 100 (which herein is movements) can be efficiently performed, thus promoting automation and unmanned execution of the operation of the work vehicle 100 (which herein is movements).

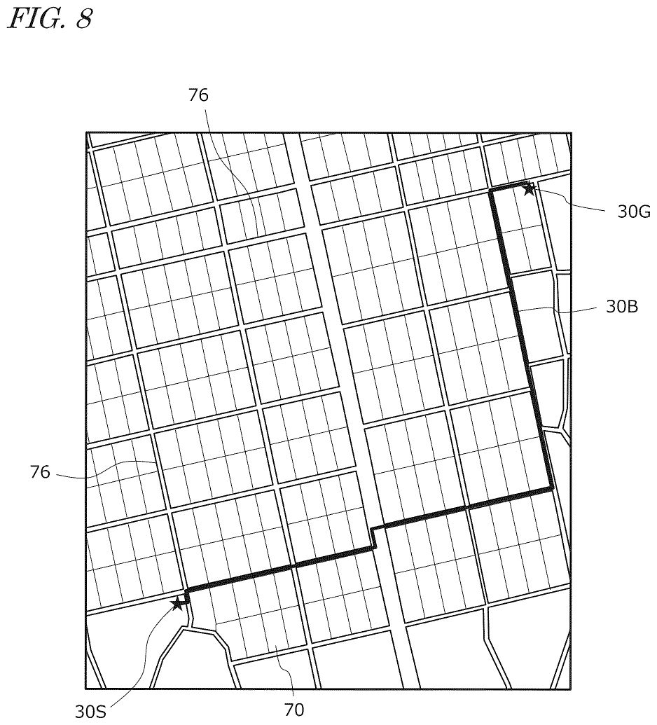

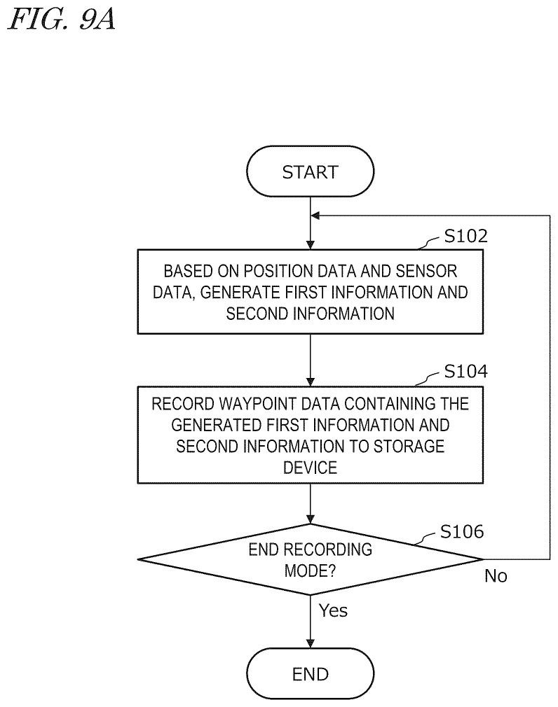

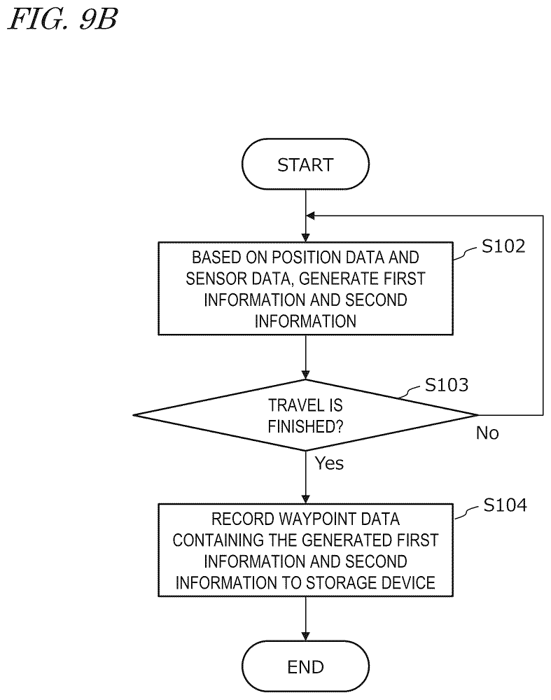

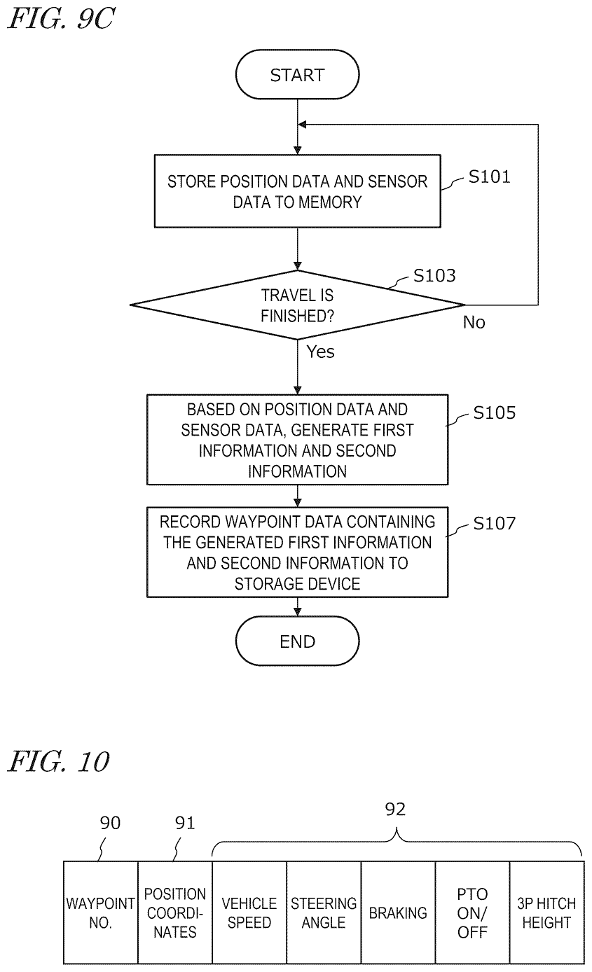

FIG. 9A is a flowchart showing an example processing to be performed in the recording mode.

The timing of beginning the recording mode is designated by the user, for example. For instance, the controller 180 may begin the recording mode when a signal including an instruction to begin the recording mode is transmitted to the controller 180 through a manipulation of the driver. For instance, the driver on the work vehicle 100 can transmit a signal including an instruction to begin the recording mode to the controller 180 by manipulating an input device such as the operation terminal 200 or a predetermined operation switch provided in the work vehicle 100. The recording mode may be begun during travel of the work vehicle 100, or begun while the work vehicle 100 is at a halt.

Once the recording mode is begun, then at step S102, while the work vehicle 100 is traveling, the controller 180 is configured or programmed to generate first information and second information based on position data that is output from the positioning device 110 and sensor data that is output from the sensor group 150. For example, the controller 180 may be configured or programmed to calculate the position (i.e., coordinates) of a reference point on the work vehicle 100 based on position data that is output from the positioning device 110, and generate (acquire) information indicating this position as the first information. Based on the position data that is output from the positioning device 110 and information indicating a relative position relationship between the positioning device 110 and the work vehicle 100 that is recorded in the storage device in advance, the controller 180 can be configured or programmed to calculate the position of the reference point on the work vehicle 100. Moreover, as the second information, the controller 180 may be configured or programmed to generate, based on sensor data that is output from the sensor group 150, information that is necessary to control various actuators to be driven during playback.

The first information and second information may be generated at any arbitrary timing. The first information and second information may be generated each time the work vehicle 100 travels a certain distance, or each time a certain period passes, for example. The aforementioned certain distance (e.g., distance between two adjacent waypoints Pr along the traveling direction of the work vehicle 100 in the example of FIG. 6A) may be set to a value on the order of several ten centimeters (cm) to several meters (m), for example. The aforementioned certain period may be set to a value in the range from 1 second to 10 seconds, for example.

At step S104, the controller 180 is configured or programmed to record waypoint data including the first information and second information generated in step S102 to the storage device 870 (see FIG. 3A). The first information and second information are recorded in association with each other.

FIG. 10 is a diagram showing an example of waypoint data. The waypoint data depicted in FIG. 10 includes a waypoint number (No.) 90, first information 91 indicating the position of the work vehicle 100, and second information 92 indicating the state of the work vehicle 100. The first information 91 represents the position coordinates of that waypoint. For example, the position coordinates may indicate a latitude and a longitude in a geographic coordinate system, or indicate position coordinates in a coordinate system other than a geographic coordinate system. In addition to a latitude and a longitude, the position coordinates may include altitude information. The second information 92 in the example of FIG. 10 includes information as to a vehicle speed, a steering angle, whether braking is applied or not, ON/OFF of the PTO shaft, and the height of the 3P hitch. The second information 92 may include only portion of such information. Alternatively, the second information 92 may include other information not shown in FIG. 10. For example, information indicating the state of a forward/reverse lever may be included in the second information 92. Alternatively, ON/OFF information of a front wheel speed increasing function (also referred to as “bi-speed turn”) may be included in the second information 92.

Until an instruction to end the recording mode is given (step S106), the controller 180 repeats the processes of step S102 and step S104. The timing of ending the recording mode may be designated by the user. For example, the controller 180 may end the recording mode when a signal including an instruction to end the recording mode is transmitted to the controller 180 through a manipulation of the driver. For instance, the driver on the work vehicle 100 can transmit a signal including an instruction to end the recording mode to the controller 180 by manipulating an input device such as the operation terminal 200 or a predetermined operation switch provided in the work vehicle 100.

FIG. 9B is a flowchart showing another example processing to be performed by the controller 180 in the recording mode. The flowchart of FIG. 9B differs from the flowchart of FIG. 9A in that step S104 is performed at a timing that is after the travel in the recording mode is finished.

In the example shown in FIG. 9B, after the travel of the work vehicle 100 in the recording mode is finished (step S103), the controller 180 performs the process of step S104. At step S104, multiple pieces of waypoint data including the first information and second information generated during travel of the work vehicle 100 in step S102 are recorded to the storage device 870. The first information and second information generated in step S102 may be temporarily stored to the storage device 870 or a storage device (e.g., a memory such as the RAM 285 shown in FIG. 3B) distinct from the storage device 870, and erased after the waypoint data has been recorded. In this example, after the travel in the recording mode is finished, waypoint data as shown in FIG. 10 is generated for each waypoint, and recorded.

FIG. 9C is a flowchart showing still another processing to be performed by the controller 180 in the recording mode. The flowchart shown in FIG. 9C differs from the flowchart shown in FIG. 9B in that the first information and the second information are generated after the travel in the recording mode is finished.

In the example shown in FIG. 9C, at step S101, while the work vehicle 100 is traveling, the controller 180 stores position data that is output from the positioning device 110 and sensor data that is output from the sensor group 150 to the memory (e.g., the RAM 285 shown in FIG. 3B). After the travel of the work vehicle 100 in the recording mode is finished (step S103), the controller 180 performs the processes of steps S105 and S107. At step S105, for each of multiple waypoints, the controller 180 generates first information and second information based on the position data and sensor data stored in the memory. At step S107, the controller 180 records multiple pieces of waypoint data, each including first information and second information, to the storage device 870. In this example, after the travel in the recording mode is finished, first information and second information are generated for each waypoint, and waypoint data as shown in FIG. 10 is recorded for each waypoint.

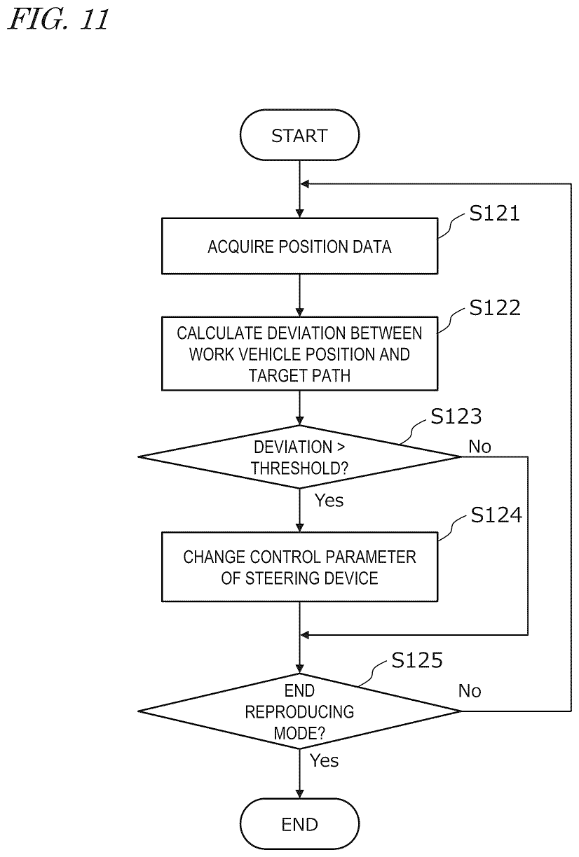

FIG. 11 is a flowchart showing an example processing to be performed in the reproducing mode.

In the reproducing mode, based on previously recorded waypoint data, the controller 180 causes the work vehicle 100 to automatically travel. The controller 180 acquires position data indicating the position of the work vehicle 100 that is output from the positioning device 110 (step S121). Next, the controller 180 calculates a deviation between the position of the work vehicle 100 and a target path (step S122). The target path is defined by positional information (first information) of multiple waypoints that are recorded in the recording mode. The deviation represents a distance between the position of the work vehicle 100 at that moment and the target path. The controller 180 determines whether the calculated deviation in position exceeds a previously-set threshold or not (step S123). If the deviation exceeds the threshold (“Yes” from step S123), the controller 180 changes a control parameter of the steering device 106 included in the driver 240 so that the deviation becomes smaller, thus changing the steering angle (step S124). If step S123 finds that the deviation does not exceed the threshold (“No” from step S123), the process of step S124 is not performed. Until receiving a signal including an instruction to end the reproducing mode (step S125), the controller 180 repeats the operation from step S121 to step S124.

In the reproducing mode, by performing the process shown in FIG. 11, for example, the controller 180 causes the work vehicle 100 to perform self-traveling along the target path. Furthermore, based on the state information (second information) corresponding to each of the multiple waypoints defining the target path, the controller 180 may control the operation of the work vehicle 100. For example, if the second information includes information of the steering angle of the wheels responsible for steering of the work vehicle 100, in addition to the processing shown in FIG. 11, a control of the steering of the work vehicle 100 may be performed based on the steering angle included in the second information. If the second information includes information of the speed of the work vehicle 100, the speed of the work vehicle 100 is controlled based on the information of speed included in the second information. Further alternatively, if an operation has been recorded such that rotation of the PTO shaft is stopped (OFF) before beginning a turn and rotation of the PTO shaft is started (ON) after completion of the turn, then the controller 180 reproduces that operation at a turn of the work vehicle 100 in the reproducing mode.

For the steering control and speed control of the work vehicle 100, control techniques such as PID control or MPC control (model predictive control) may applied. By applying such control techniques, the control of bringing the work vehicle 100 closer to a target path and a target speed can be made smooth.

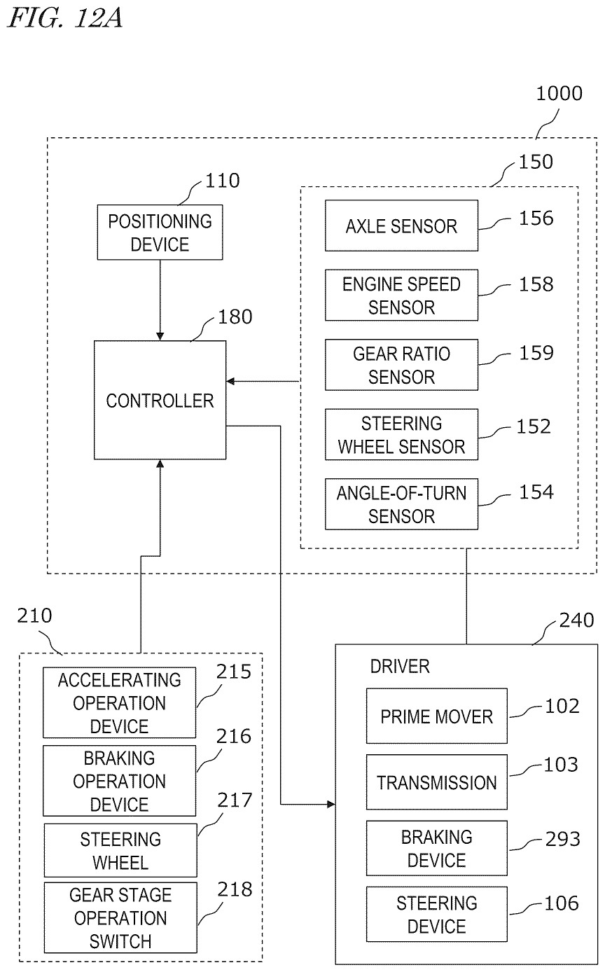

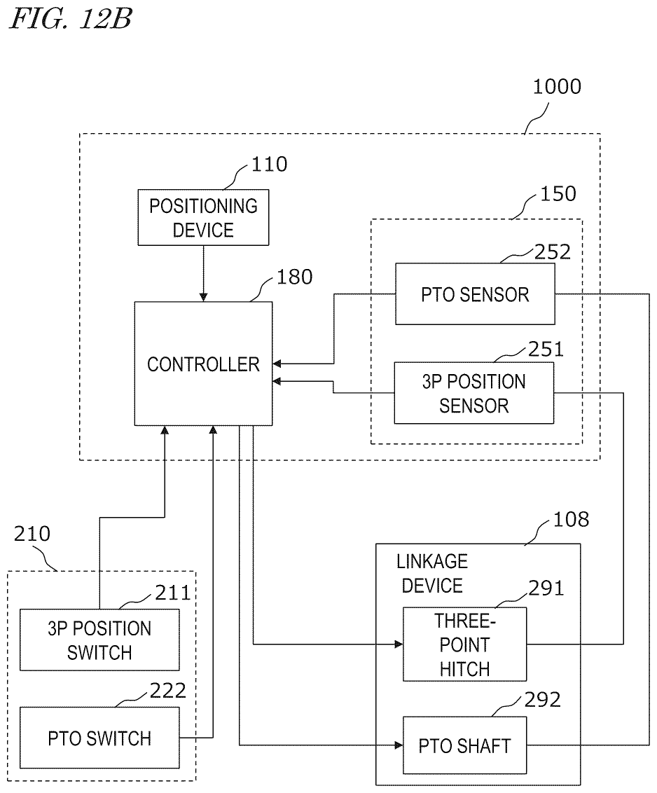

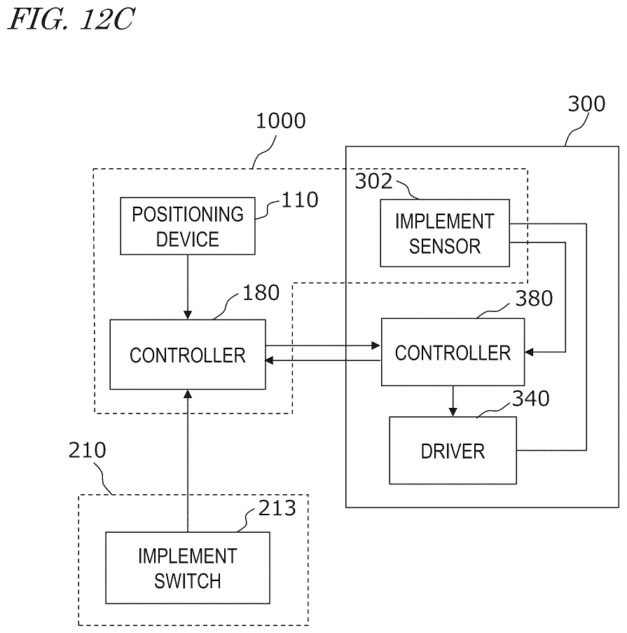

With reference to FIG. 12A, an example processing to be performed by the controller 180 in a case where the second information includes information concerning the traveling state of the work vehicle 100 will be described. FIG. 12A is a schematic diagram for describing an example processing to be performed by the controller 180 of the travel control system 1000. In addition to the travel control system 1000, FIG. 12A also shows the driver 240 and the operation switches 210. For simplicity, some component elements are omitted from illustration in FIG. 12A.

By controlling the prime mover 102, the braking device (brakes) 293, and the transmission 103 included in the driver 240, the controller 180 is configured or programmed to control the speed of the work vehicle 100. The braking device 293 applies braking to the axle that rotates the wheels 104 of the work vehicle 100. Specifically, by controlling the engine speed of the prime mover (engine) 102 and/or the gear ratio of the transmission 103, the speed of the work vehicle 100 can be controlled. For example, the transmission 103 has multiple gear stages, and the controller 180 is configured or programmed to control the gear ratio of the transmission 103 by switching the gear stages of the transmission 103. The multiple gear stages of the transmission 103 may be configured by a combination of multiple main gear stages and multiple range gear stages. When the work vehicle 100 is performing manual traveling, the controller 180 is configured or programmed to control the speed of the work vehicle 100 by controlling the prime mover 102, the braking device (brakes) 293, and the transmission 103 in response to the driver's manipulation of an accelerating operation device 215 (e.g., an accelerator lever or an accelerator pedal), a braking operation device 216 (e.g., a brake pedal), and/or a gear stage operation switch 218 (e.g., a shift lever). The gear stage operation switch 218 is a switch for selecting a gear stage of the transmission 103. The controller 180 may further switch between a two-wheel drive mode and a four-wheel drive mode in response to the driver's manipulation.

In the recording mode, the controller 180 consecutively acquires sensor data that is output from vehicle speed sensors such as the axle sensor 156, an engine speed sensor 158, and a gear ratio sensor 159 that detects information of the gear ratio of the transmission 103. Based on such sensor data, as second information, the controller 180 generates and records information of the speed of the work vehicle 100, information of the engine speed of the work vehicle 100, and information of the gear ratio of the transmission 103, in association with the positional information (first information) of each waypoint. In such a case, in the reproducing mode, the controller 180 is configured or programmed to control the speed of the work vehicle 100 by controlling the prime mover 102, the transmission 103, and the braking device 293 included in the driver 240 based on the second information that was recorded in the recording mode. The gear ratio sensor 159 may be a sensor which is provided on a rotation axis within the transmission 103 and which detects the gear ratio, or a shift position sensor that detects the position of the shift lever (gear stage operation switch 218) for selecting a gear stage to identify the selected gear stage. Without being limited to information that indicates the gear ratio itself, information of the gear ratio of the transmission 103 may be information that identifies a selected gear stage among the plurality of gear stages of the transmission 103, for example. Since one gear stage corresponds to one gear ratio, identifying a gear stage allows the gear ratio to be identified.

The work vehicle 100 may have a bi-speed turn mode (front wheel speed increasing function). A bi-speed turn is an operation in which, when a driver steers the steering wheel so much that the steering angle of the front wheels exceeds a threshold, the speed of the front wheels is increased. Performing a bi-speed turn allows the turning radius to be decreased, thus resulting in a smoother turn. The work vehicle 100 may include a solenoid (referred to as a “bi-speed solenoid”) to drive a clutch that switches the bi-speed turn mode ON/OFF. The controller 180 can switch the bi-speed solenoid ON/OFF via a hydraulic circuit. When the bi-speed solenoid is ON, the rotational speed of the front wheels is about twice that of the case where the bi-speed solenoid is OFF.

The second information may further include information concerning the traveling mode of the work vehicle 100. For example, information concerning the traveling mode of the work vehicle 100 may include information as to forward travel or backward travel. Information concerning the traveling mode may include information as to whether the traveling mode of the work vehicle 100 is in a four-wheel drive mode or a two-wheel drive mode. Information concerning the traveling mode may include information as to whether the bi-speed turn mode is ON or OFF. Information concerning the traveling mode may further include information as to whether an automatic single brake mode is ON or OFF. The automatic single brake mode is a mode which, when ON, applies slight braking to the inner rear wheels when the steering angle of the front wheels 104F (which are the wheels responsible for steering) exceeds a predetermined value during travel. In the reproducing mode, the controller 180 is configured or programmed to control the traveling mode of the work vehicle 100, by controlling the prime mover 102, the transmission 103, and the braking device 293 included in the driver 240 based on the second information that was recorded in the recording mode.

The controller 180 changes the steering angle of the front wheels 104F (which are the wheels responsible for steering of the work vehicle 100) by controlling the steering device 106, and changes the azimuth of the work vehicle 100 by changing the steering angle of the wheels responsible for steering. When the work vehicle 100 is performing manual traveling, the controller 180 changes the steering angle of the wheels responsible for steering and the azimuth of the work vehicle 100 of the work vehicle 100 by controlling the steering device 106 in response to the driver's manipulation of the steering wheel 217.

In the recording mode, based on sensor data (measurement values) that is output from the steering wheel sensor 152 and/or the angle-of-turn sensor 154, the controller 180 is configured or programmed to acquire, as second information, information of the steering angle of the wheels responsible for steering of the work vehicle 100. In such a case, in the reproducing mode, the controller 180 is configured or programmed to control steering of the work vehicle 100 by controlling the hydraulic device or the electric motor included in the steering device 106 based on the second information that was recorded in the recording mode.

The second information may further include information concerning the attitude of the work vehicle 100. The attitude of the work vehicle 100 is represented by a roll angle θ_{R}, a pitch angle θ_{P}, and a yaw angle θ_{Y}, for example. A roll angle θ_{R} represents the amount of rotation of the work vehicle 100 around its front-rear axis. A pitch angle θ_{P} represents the amount of rotation of the work vehicle 100 around its right-left axis. A yaw angle θ_{Y} represents the amount of rotation of the work vehicle 100 around its top-bottom axis. The attitude may be defined by an Euler angle or other angles, or a quaternion. The controller 180 is configured or programmed to acquire information concerning the attitude of the work vehicle 100 based on data that is output from the IMU 115, for example.

With reference to FIG. 12B, an example processing to be performed by the controller 180 in a case where the second information includes information concerning the state of the linkage device 108 for enabling linking of the implement 300 will be described. FIG. 12B is a schematic diagram for describing an example processing to be performed by the controller 180 of the travel control system 1000. In addition to the travel control system 1000, FIG. 12B also shows the linkage device 108 and the operation switches 210.

As shown in FIG. 12B, the linkage device 108 includes a three-point hitch 291 for connecting the implement 300, and a PTO shaft 292 for supplying motive power of rotation to the implement 300. The operation switches 210 include a 3P position switch 211 for performing a manipulation of changing the height of the three-point hitch 291, and a PTO switch 222 for performing a manipulation of switching ON/OFF the rotation of the PTO shaft 292. The sensor group 150 includes a 3P position sensor 251 to detect the position in the height direction of the three-point hitch 291, and a PTO sensor 252 to detect rotation ON/OFF of the PTO shaft 292. Each of the linkage device 108, the operation switches 210, and the sensor group 150 may include other component elements, however, for simplicity, some component elements are omitted from illustration in FIG. 12B. The controller 180 is connected to the 3P position sensor 251, the PTO sensor 252, the three-point hitch 291, and the PTO shaft 292. The controller 180 is configured or programmed to perform communications between itself and these component elements by utilizing a communication protocol such as CAN.

The controller 180 is configured or programmed to control the height of the three-point hitch 291 and switching ON/OFF of the rotation of the PTO shaft 292. In a case where the work vehicle 100 is operating via manual operation of the driver, the controller 180 is configured or programmed to change the height of the three-point hitch 291 in response to the driver's manipulation of the 3P position switch 211, and switch rotation ON/OFF of the PTO shaft 292 in response to the driver's manipulation of the PTO switch 222.

In the recording mode, based on sensor data that is output from the 3P position sensor 251, the controller 180 is configured or programmed to generate, as second information, information concerning the height of the three-point hitch 291. In such a case, in the reproducing mode, the controller 180 is configured or programmed to control the height of the three-point hitch 291 based on the second information that was recorded in the recording mode. Moreover, in the recording mode, the controller 180 is configured or programmed to acquire, as second information, information concerning rotation ON/OFF of the PTO shaft 292 based on sensor data that is output from the PTO sensor 252. In such a case, in the reproducing mode, the controller 180 is configured or programmed to control rotation ON/OFF of the PTO shaft 292 based on the second information that was recorded in the recording mode.

With reference to FIG. 12C, an example processing to be performed by the controller 180 in a case where the work vehicle 100 has the implement 300 linked thereto and the second information includes information concerning the state of the implement 300 will be described. FIG. 12C is a schematic diagram for describing an example processing to be performed by the controller 180 of the travel control system 1000. In addition to the travel control system 1000, FIG. 12C also shows the implement 300 and the operation switches 210. For simplicity, some component elements are omitted from illustration in FIG. 12C.

As shown in FIG. 12C, the implement 300 includes the driver 340 to perform necessary operations for the implement 300 to perform predetermined tasks, the controller 380 configured or programmed to control the operation of the driver 340, and one or more implement sensors 302 to detect the state of the driver 340 and output sensor data. The driver 340 includes a device that is adapted to the use of the implement 300, such as a hydraulic device, an electric motor, or a pump, for example. The implement sensor 302 has a structure that is adapted to the driver 340, and includes a hydraulic sensor, for example. The operation switches 210 include an implement switch 213 to manipulate the operation of the implement 300.

By sending a command to control the operation of the driver 340 to the controller 380, the controller 180 is configured or programmed to control the operation of the implement 300. In a case where the work vehicle 100 is operating via manual operation of the driver, the controller 180 is configured or programmed to control the operation of the implement 300 by sending a command to the controller 380 to control the operation of the driver 340, in response to the driver's manipulation of the implement switch 213.

In the recording mode, the controller 180 is configured or programmed to acquire or generate, as second information, information concerning the state of the implement 300, based on sensor data that is output from the implement sensor 302. For example, the controller 380 may be configured or programmed to generate second information concerning the state of the implement 300 based on sensor data that is output from the implement sensor 302, and transmit the second information to the controller 180. Alternatively, the controller 180 may be configured or programmed to receive sensor data that is output from the implement sensor 302, and generate information concerning the state of the implement 300 via the controller 380. In such a case, in the reproducing mode, the controller 180 is configured or programmed to control the operation of the implement 300 by causing the controller 380 to control the operation of the driver 340 based on the second information that was recorded in the recording mode.

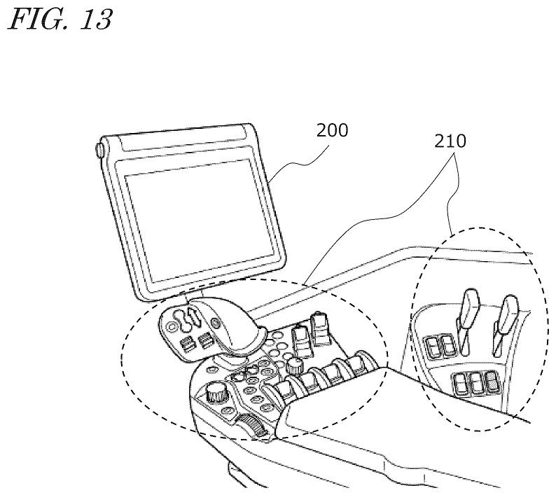

FIG. 13 is a diagram showing an example of an operation terminal 200 and operation switches 210 provided inside the cabin 105 of the work vehicle 100. Inside the cabin 105, operation switches 210 including a plurality of switches that can be manipulated by the driver are provided. The operation switches 210 may include examples of operation switches that have been described with reference to FIG. 12A, FIG. 12B, and FIG. 12C.

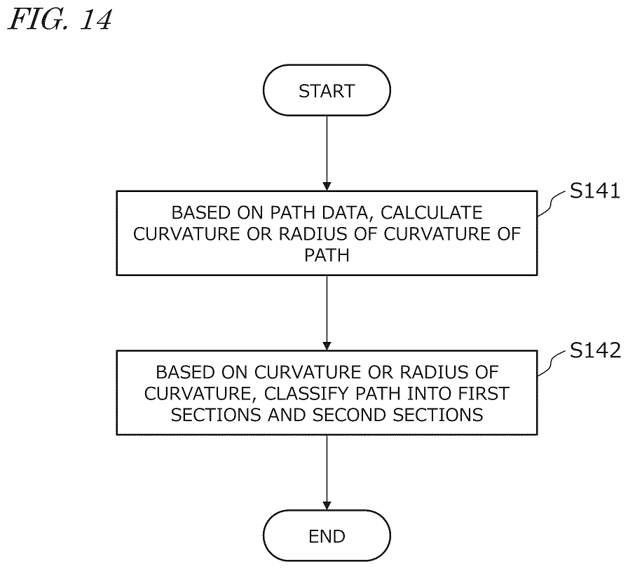

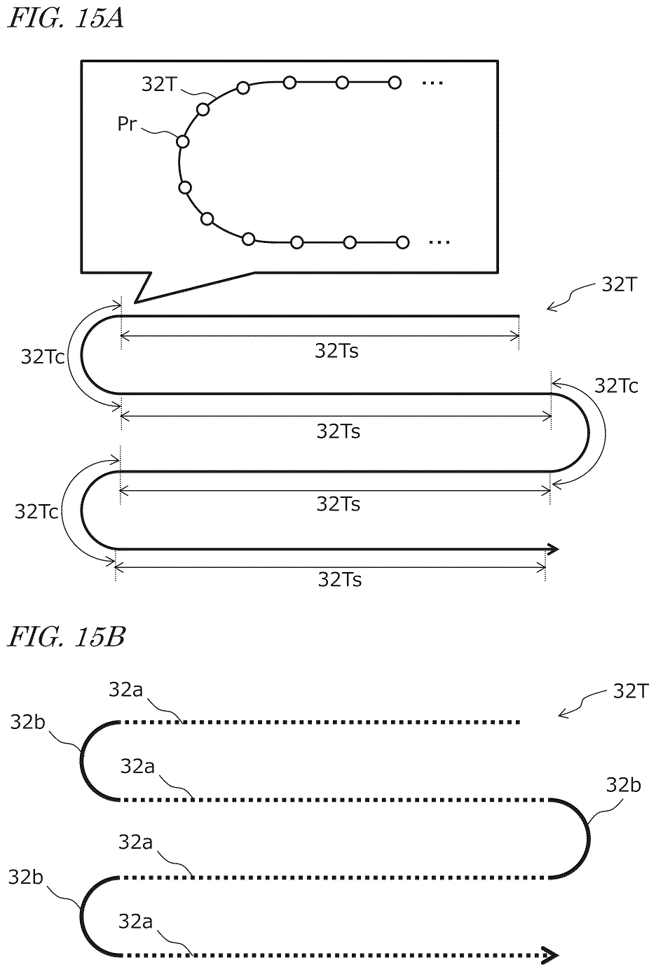

FIG. 14 is a flowchart showing an example processing to be performed by the controller 180. FIG. 15A and FIG. 15B are schematic diagrams for describing the processing performed by the controller 180 in the example of FIG. 14. The processing shown in FIG. 14 may be performed, for example, after the recording mode is ended, i.e., after recording of multiple pieces of waypoint data is finished and before self-driving in the reproducing mode is begun.

At step S141, based on the recorded path data, the controller 180 calculates a curvature or radius of curvature of the path. For example, the controller 180 acquires path data (i.e., multiple pieces of waypoint data) that is recorded in the storage device 870). FIG. 15A schematically shows an example of path data that is recorded in the storage device 870. A path 32T is defined by multiple pieces of waypoint data Pr, although only some of the waypoint data Pr is depicted within a balloon in the figure, for simplicity. The path 32T is a path of traveling within a field, for example. The path 32T includes a plurality of parallel main paths 32Ts and a plurality of turning paths 32Tc connecting between the plurality of main paths 32Ts. As in the example shown in FIG. 6A, for instance, each of the plurality of main paths 32Ts may be a path of traveling between two adjacent crop rows (e.g., rows of trees). In such a case, each of the plurality of turning paths 32Tc may be a path of turning in a headland before and after traveling between the two adjacent crop rows. When traveling along such a path, the work vehicle 100 may perform a task using the implement 300 while traveling along the main paths 32Ts, but does not perform any task using the implement 300 when traveling along the turning paths 32Tc, for example.

Based on the acquired waypoint data Pr, the controller 180 calculates a curvature, or a radius of curvature (i.e., an inverse of curvature), at each point on the path 32T. Since a radius of curvature is an inverse of curvature, calculating one of a curvature or a radius of curvature allows the other to be determined as an inverse thereof. A method of calculating a curvature or a radius of curvature will be described below.

At step S142, based on the curvature calculated at step S141, the controller 180 classifies the path 32T into first sections 32a having a curvature that is equal to or less than a threshold and second sections 32b having a curvature that is greater than the threshold. The controller 180 may perform the path classification based on the radius of curvature of the path as calculated at step S141. When the classification is based on the radius of curvature, the classification may be made between first sections 32a having a radius of curvature equal to or greater than a threshold and second sections 32b having a radius of curvature smaller than the threshold, for example. The threshold for radius of curvature is different from the threshold for curvature. In this example, the plurality of main paths 32Ts may be classified as first sections 32a, whereas the plurality of turning paths 32Tc may be classified as second sections 32b. In the figure, first sections 32a are indicated by dotted lines, whereas second sections 32b are indicated by solid lines. As in this example, a path may include a plurality of first sections and a path may include a plurality of second sections. In a case where the path includes a plurality of first sections, a second section may exist between adjacent first sections. In a case where the path includes a plurality of second sections, a first section may exist between adjacent second sections.

By performing the aforementioned path classification prior to beginning self-driving under the reproducing mode, the controller 180 can, between first sections and second sections, vary the control method for the operation of the work vehicle 100 in the reproducing mode, for example. As a result of this, iterative operations of the work vehicle 100 can be efficiently performed. Examples of varying the control method or the like for the operation of the work vehicle 100 in the reproducing mode between first sections and second sections will be described below.

For example, in the reproducing mode, the controller 180 varies the operation of the work vehicle 100 (which in this example is the traveling state of the work vehicle 100) between when the work vehicle 100 is traveling in a first section and when the work vehicle 100 is traveling in a second section.

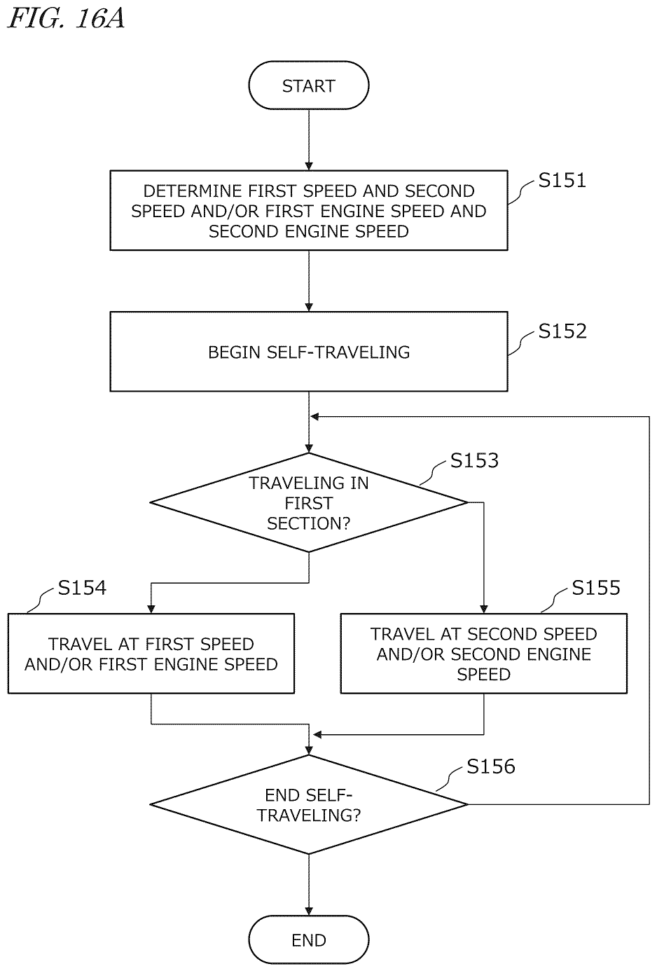

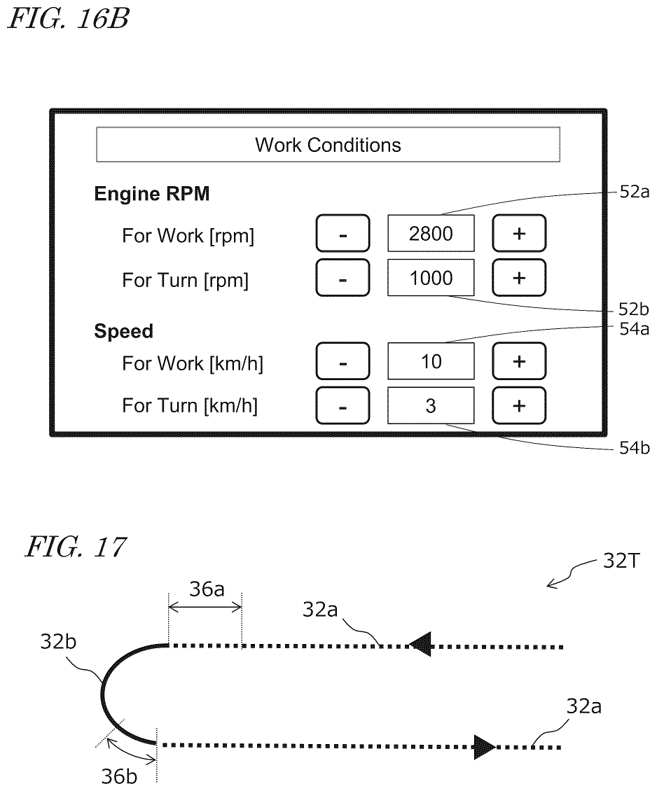

FIG. 16A is a flowchart showing an example processing to be performed by the controller 180 in the reproducing mode. In this example, in the reproducing mode, the controller 180 varies the speed and/or the engine speed of the work vehicle 100 between when the work vehicle 100 is traveling in a first section and when the work vehicle 100 is traveling in a second section, for example.

At step S151, the controller 180 determines a first speed and a second speed of the work vehicle 100 and/or a first engine speed and a second engine speed of the work vehicle 100. The second speed is smaller than the first speed. The second engine speed is smaller than the first engine speed.

The determination of the first speed and the second speed is made based on a user input, for example. The determination of the first engine speed and the second engine speed is made based on a user input, for example. FIG. 16B shows an example of a screen image to be displayed on a terminal device that is operated by a user who performs manipulations under the reproducing mode. The screen image of FIG. 16B includes a GUI for allowing the user to make settings under the reproducing mode. In the screen image of FIG. 16B, the user can input the first speed and the second speed in boxes 54a and 54b, respectively, and input the first engine speed and the second engine speed in boxes 52a and 52b, respectively.

At step S152, the controller 180 begins self-traveling of the work vehicle 100 under the reproducing mode. In the self-traveling, while the work vehicle 100 is traveling in a first section of the path (“Yes” from step S153), the controller 180 causes the work vehicle 100 to travel at the first speed and/or the first engine speed at step S154. During self-traveling, while the work vehicle 100 is traveling in a second section of the path (“No” from step S153), the controller 180 causes the work vehicle 100 to travel at the second speed and/or the second engine speed at step S155. In other words, even when information of speed and/or engine speed is included in the second information included in the multiple pieces of waypoint data, self-traveling of the work vehicle 100 is performed by using the values determined in step S151. Until a signal including an instruction to end self-traveling of the work vehicle 100 under the reproducing mode is received (step S156), the controller 180 repeats the processes of step S153, step S154 and step S155.

Because the controller 180 can vary the operation of the work vehicle 100 between when the work vehicle 100 is traveling in a first section and when the work vehicle 100 is traveling in a second section in the reproducing mode, control of the operation of the work vehicle 100 can be efficiently performed. As in the above-described example, a speed and/or an engine speed that is different from the second information included in the multiple pieces of waypoint data may be set. For example, in a case of using an implement that is distinct from the implement that has actually traveled along that path in the recording mode, self-driving under the reproducing mode can be performed in a control method that is determined in accordance with the type of the implement, whereby the recorded data can be effectively utilized.

Note that, in a case where the second information included in the multiple pieces of waypoint data includes information of the speed of the work vehicle 100, determination of the first speed and the second speed may be made based on the second information. In other words, within the path data, based on the second information included in the multiple pieces of waypoint data that have been classified into first sections, the controller 180 can determine a first speed, and, based on second information included in the multiple pieces of waypoint data that have been classified into second sections, determine a second speed.

FIG. 17 is a schematic diagram of the path 32T for describing another example processing to be performed by the controller 180.

FIG. 17 only shows a portion of the path 32T. As shown in FIG. 15B, the path 32T includes a plurality of first sections 32a and a plurality of second sections 32b connecting between a plurality of first sections 32a. In this example, the controller 180 can decelerate the work vehicle 100 while the work vehicle 100 is traveling in a first section in the reproducing mode, and accelerate the work vehicle 100 while the work vehicle 100 is traveling in a second section in the reproducing mode. For example, as shown in FIG. 17, while the work vehicle 100 is traveling in a first section 32a in the reproducing mode, the controller 180 may decelerate the work vehicle 100 in a portion 36a leading to a second section 32b. While the work vehicle is traveling in a second section 32b in the reproducing mode, the controller 180 may accelerate the work vehicle 100 in a portion 36b leading to a first section 32a.

By performing such control of self-traveling of the work vehicle 100, travel can be carried out in a more smooth manner based on the first and second speeds and/or the first and second engine speeds in a case where self-traveling of the work vehicle 100 is performed as in the example of FIG. 16A, for instance.

In the reproducing mode, the controller 180 may vary the state of the linkage device 108 for enabling linking of the implement 300 between when the work vehicle 100 is traveling in a first section and when the work vehicle 100 is traveling in a second section. For example, in the reproducing mode, the controller 180 may vary the height of a three-point hitch that adjusts the height of the implement 300, or switch rotation ON or OFF of the PTO shaft for supplying motive power to the implement 300, between when the work vehicle 100 is traveling in a first section and when the work vehicle 100 is traveling in a second section. For example, in the reproducing mode, the controller 180 ensures that the height of the three-point hitch assumed when the work vehicle 100 is traveling in a second section is higher than the height of the three-point hitch assumed when the work vehicle 100 is traveling in a first section. For example, in the reproducing mode, the controller 180 may turn rotation of the PTO shaft ON when the work vehicle 100 is traveling in a first section, and turn rotation of the PTO shaft OFF when the work vehicle 100 is traveling in a second section. By controlling the height of the three-point hitch and/or rotation of the PTO shaft in the above manner, it becomes possible to efficiently perform travel and other operations of the work vehicle 100 traveling among a plurality of crop rows within a field while performing work, as in the example of FIG. 6A.

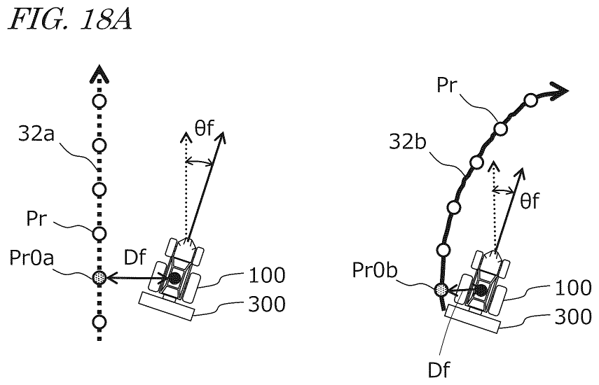

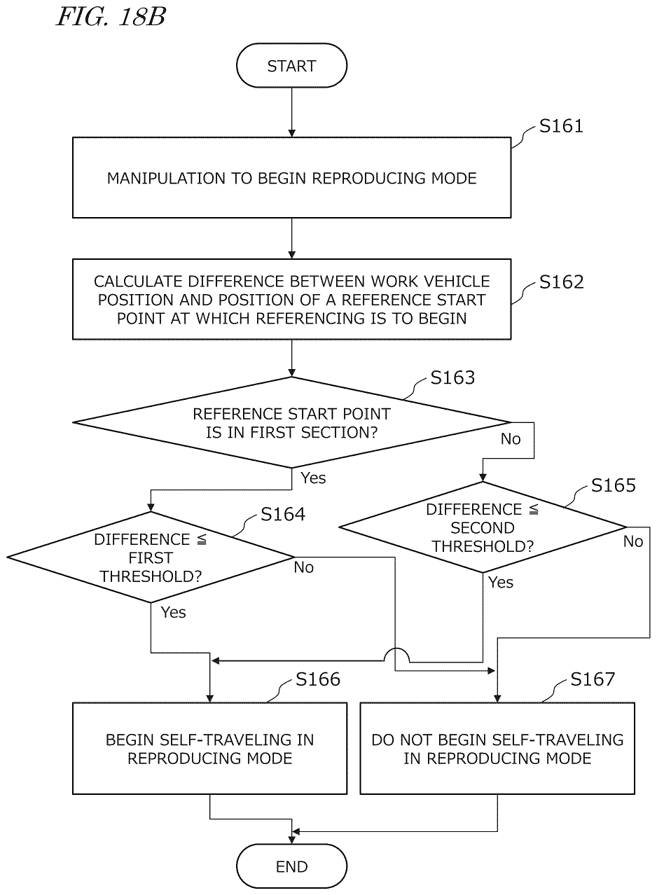

FIG. 18A is a schematic diagram of the path 32T and the work vehicle 100 for describing an example processing that is performed by the controller 180. FIG. 18B is a flowchart showing an example processing that is performed by the controller 180 when a manipulation for beginning the reproducing mode is made. FIG. 18A provides a schematic diagram of a situation where the work vehicle 100 is about to begin self-driving under the reproducing mode by using path data of the path 32T. In this example, self-driving under the reproducing mode is about to begin midway the path 32T. Shown on the left side of FIG. 18A is an example where self-driving under the reproducing mode is about to begin with waypoint data Pr0a of a first section 32a of the path 32T as a reference start point. Shown on the right side of FIG. 18A is an example where self-driving under the reproducing mode is about to begin with waypoint data Pr0b of a second section 32b of the path 32T as a reference start point.

At step S161, the controller 180 receives a signal including an instruction to begin self-driving under the reproducing mode. For example, when a manipulation for beginning self-driving under the reproducing mode is made by e.g. the user, the controller 180 receives a signal including an instruction to begin self-driving under the reproducing mode. For example, the user may operate an input device such as the operation terminal 200 to perform the manipulation for beginning self-driving under the reproducing mode. The manipulation for beginning self-driving under the reproducing mode includes a manipulation for specifying path data to be used in the reproducing mode. At step S161, the controller 180 may also receive a signal that specifies path data to be used in the reproducing mode. In this example, path data concerning the path 32T is specified. Furthermore, at step S161, the controller 180 may also acquire position data concerning the position of the work vehicle 100.

At step S162, the controller 180 calculates a difference Df between the position of the work vehicle 100 when the signal at step S161 is received (e.g., the position of a reference point on the work vehicle 100), and the position of a reference start point at which referencing is to begin with the manipulation at step S161, in the path data that is specified by the signal received in step S161. As the reference start point, the controller 180 may specify waypoint data Pr that is the closest from the position of the work vehicle 100 when receiving the signal in step S161, for example.

The controller 180 compares the difference Df calculated in step S162 against a predetermined value (threshold). If the reference start point is included in a first section of the path (“Yes” from step S163) as in the left example of FIG. 18A, the controller 180 compares the difference Df calculated in step S162 against a first predetermined value. If the difference Df calculated in step S162 is equal to or less than the first predetermined value (“Yes” from step S164), then at step S166, the controller 180 begins self-traveling of the work vehicle 100. If the difference Df calculated in step S162 is greater than the first predetermined value (“No” from step S164), then at step S167, the controller 180 ends the process without beginning self-traveling of the work vehicle 100.

If the reference start point is included in a second section of the path (“No” from step S163) as in the right example of FIG. 18A, the controller 180 compares the difference Df calculated in step S162 against a second predetermined value. The second predetermined value is smaller than the first predetermined value. If the difference Df calculated in step S162 is equal to or less than the second predetermined value (“Yes” from step S165), then at step S166, the controller 180 begins self-traveling of the work vehicle 100. If the difference Df calculated in step S162 is greater than the second predetermined value (“No” from step S165), then at step S167, the controller 180 ends the process without beginning self-traveling of the work vehicle 100.

Thus, the controller 180 can set a more stringent condition for beginning self-driving under the reproducing mode for a second section than for a first section. In other words, the threshold for deviation in position from a target path can be made smaller in a second section than in a first section. Because a second section has a larger curvature than does a first section, in order to accurately track a target path that is defined by the path data, any deviation from the target path in the second section at the beginning is preferably smaller than in the first section. Because the controller 180 performs the aforementioned control method, it is possible to accurately track the target path.

As the condition for beginning self-driving under the reproducing mode, the controller 180 may also set a smaller threshold for deviation in an azimuth from a target path for a second section than for a first section. In other words, when a manipulation for causing the work vehicle 100 to begin traveling in the reproducing mode is made by the user, the controller 180 compares, against a predetermined value (threshold), a difference θf between the azimuth of the work vehicle 100 when the manipulation is made and the azimuth of the work vehicle at a reference start point in the path data at which referencing is to begin with the manipulation. In FIG. 18A, the azimuth of the work vehicle 100 when a manipulation for causing the work vehicle 100 to begin traveling in the reproducing mode is made is indicated with a solid arrow, whereas the azimuth of the work vehicle at the reference start point Pr0a or Pr0b is indicated with a dotted arrow. The controller 180 begins self-traveling of the work vehicle 100 when the difference θf in azimuth is equal to or less than the predetermined value, but does not begin self-traveling of the work vehicle 100 when the difference θf in azimuth is greater than the predetermined value. The predetermined value (threshold) is made greater when the reference start point is included in a first section of the path than when the reference start point is included in a second section of the path.

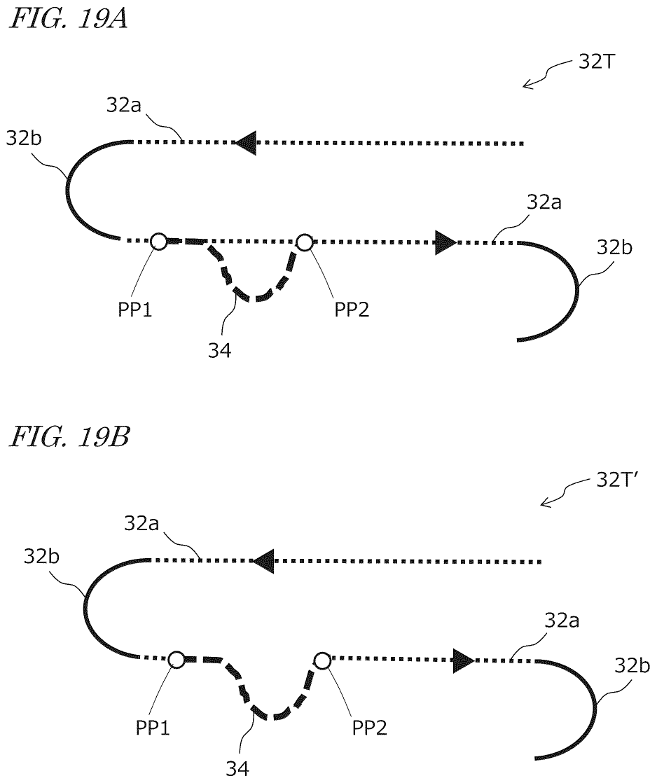

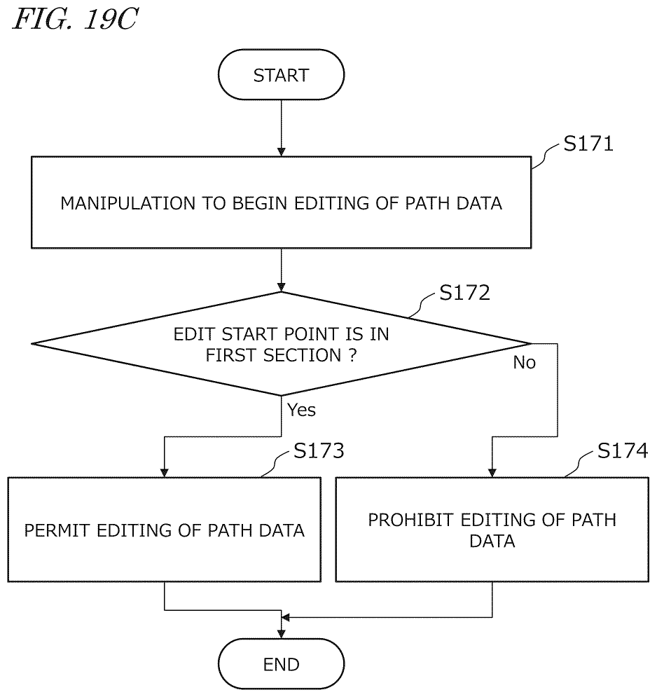

FIG. 19A and FIG. 19B are schematic diagrams of the path 32T for describing an example processing that is performed by the controller 180. FIG. 19C is a flowchart showing an example processing that is performed by the controller 180.

FIG. 19A and FIG. 19B schematically show editing of path data being performed. In this example, editing of path data is being performed by replacing a portion of the path 32T (which herein is a path between position PP1 and position PP2) with a newly generated path 34 connecting between position PP1 and position PP2. The post-edit path is shown as path “32T” in FIG. 19B. Such editing of path data may be performed as the work vehicle 100 actually travels along the path 34 between position PP1 and position PP2, for example. After the editing is performed, the controller 180 records path data of the post-edit path 32T′ to the storage device 870. Both of the path data of the pre-edit path 32T and the path data of the post-edit path 32T′ may be recorded to the storage device 870.

FIG. 19C shows an example processing that is performed by the controller 180 when a manipulation for beginning editing of path data is made.

As shown in FIG. 19C, at step S171, the controller 180 receives a signal including an instruction to begin editing of path data. For example, when a manipulation for beginning editing of path data is performed by e.g. the user (e.g., the driver of the work vehicle 100), the controller 180 receives a signal including an instruction to begin editing of path data. For example, the user may operate an input device such as the operation terminal 200 to perform the manipulation for beginning editing of path data. In the example of FIG. 19A and FIG. 19B, the manipulation for beginning editing of path data may be performed in a state where the work vehicle 100 is located at position PP1. The manipulation for beginning self-driving under the reproducing mode includes a manipulation for specifying path data to be used in the reproducing mode. At step S171, the controller 180 may also receive a signal that specifies path data to be used in the reproducing mode. In this example, path data concerning the path 32T is specified. Moreover, at step S171, the controller 180 may also acquire position data concerning the position of the work vehicle 100.

At step S172, the controller 180 determines whether the point at which editing is to be begun (“edit start point”) is included in a first section of the path 32T or not. If the edit start point is included in a first section of the path 32T (“Yes” from step S172), editing of the path data of the path 32T is permitted to be begun. If the edit start point is included in a second section of the path 32T (“No” from step S172), editing of the path data of the path 32T is not permitted to be begun.

Thus, the controller 180 can permit editing of path data only in first sections. Because a second section has a larger curvature than does a first section, if editing of path data occurs midway a second section, the accuracy of path tracking may not be sufficient when the work vehicle 100 comes to a junction, for example. Because the controller 180 performs the aforementioned control method, it becomes possible to accurately track a target path that is defined by the post-edit path data.

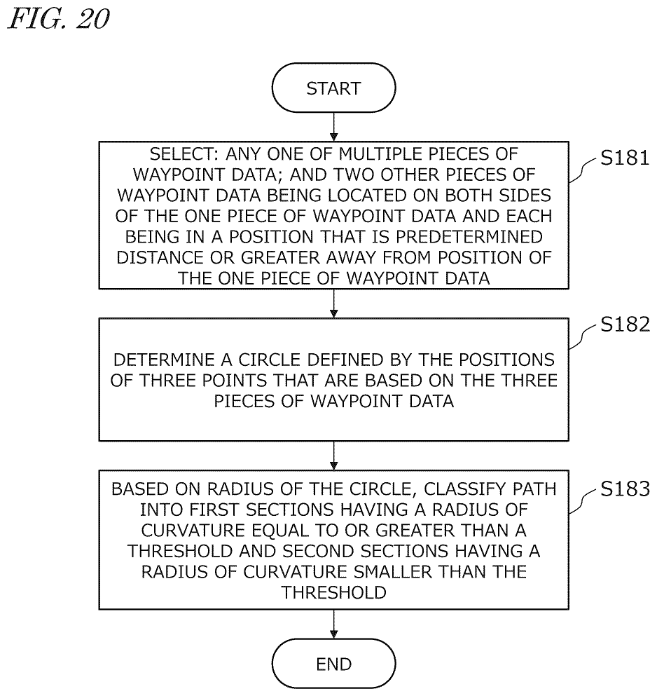

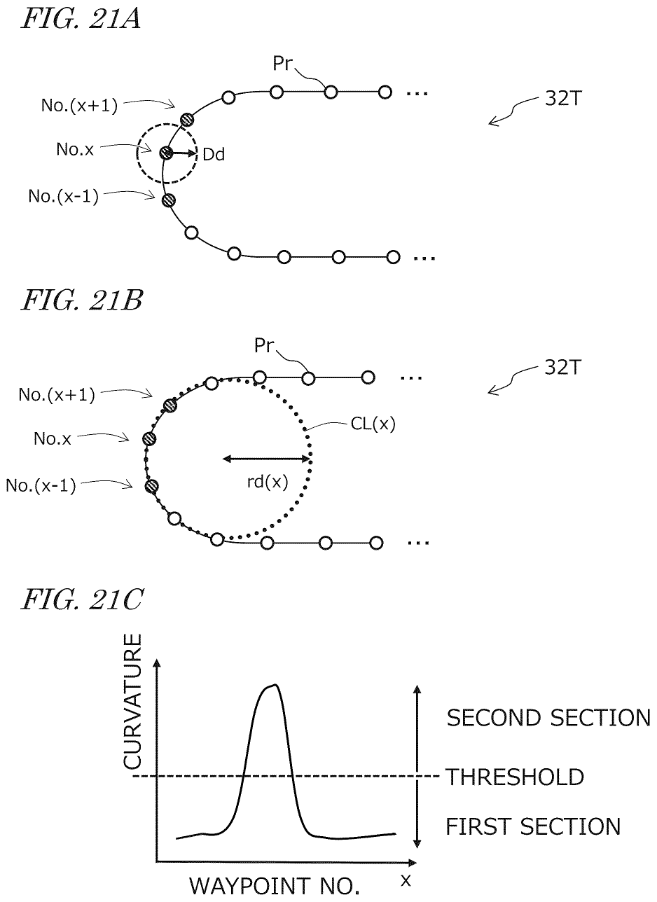

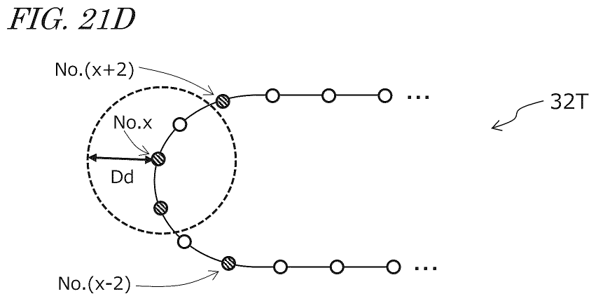

FIG. 20 is a flowchart showing an example processing to be performed by the controller 180. FIG. 21A, FIG. 21B, FIG. 21C and FIG. 21D are schematic diagrams for describing an example method of classifying a path into first sections and second sections. With reference to FIG. 20 as well as FIGS. 21A to 21D, the example method of classifying a path into first sections and second sections will be described.

As shown in FIG. 20, at step S181, the controller 180 selects three pieces of waypoint data including any one of the multiple pieces of waypoint data included in the path data, and two other pieces of waypoint data being located on both sides of the one piece of waypoint data and each being in a position that is a predetermined distance or greater away from the position of the one piece of waypoint data.

FIG. 21A is a diagram schematically showing an example of path data that is recorded in the storage device 870, depicting a portion of the path data of the path 32T. In the example of FIG. 21A, from among the multiple pieces of waypoint data Pr included in the path data of the path 32, the controller 180 selects three pieces of waypoint data No. (x−1) to No. (x+1), including, waypoint data No. x, and two other pieces of waypoint data No. (x−1) and No. (x+1) being located on both sides of waypoint data No. x and each being in a position that is a predetermined distance Dd or greater away from the position of waypoint data No. x. The two pieces of waypoint data located on both sides of waypoint data No. x are determined by selecting, on each of the two sides, a piece of waypoint data that is the closest to waypoint data No. x, among all pieces of waypoint data that are the predetermined distance Dd or greater away from the position of waypoint data No. x.

The value of the predetermined distance Dd may be arbitrarily set. The value of the predetermined distance Dd may be changed in accordance with the shape of the path, for example. In the example of FIG. 21A, the predetermined distance Dd is smaller than the interval between the positions of consecutive pieces of waypoint data among the multiple pieces of waypoint data. As in the example of FIG. 21D, the predetermined distance Dd may be greater than the interval between the positions of consecutive pieces of waypoint data among the multiple pieces of waypoint data. In the example of FIG. 21D, three pieces of waypoint data No. (x−2), No. x and No. (x+2) are being selected, including waypoint data No. x, and two pieces of waypoint data No. (x−2) and No. (x+2) being located on both sides of waypoint data No. x and each being located the predetermined distance Dd or greater away from the position of waypoint data No. x.

At step S182, the controller 180 determines a circle defined by the positions of three points that are based on the three pieces of waypoint data selected in step S181. In the example of FIG. 21B, the controller 180 determines a circle CL(x) defined by the positions of three points that are based on the three pieces of waypoint data No. (x−1) to No. (x+1).

At step S183, based on the radius of the circle determined in step S182, the controller 180 classifies the path into first sections having a radius of curvature equal to or greater than a threshold and second sections having a radius of curvature smaller than the threshold. In the example of FIG. 21B, the controller 180 determines the radius rd(x) of the circle CL(x) determined in step S182 as the radius of curvature at waypoint data No. x, for example. The controller 180 can determine the radii of curvature at the respective pieces of waypoint data, and classify them into first sections having a radius of curvature equal to or greater than a threshold and second sections having a radius of curvature smaller than the threshold.

The controller 180 may classify a path into first sections and second sections based on the curvature of each point in the path. As described earlier, since a radius of curvature is an inverse of curvature, calculating one of a curvature or a radius of curvature allows the other to be determined as an inverse thereof. In the example of FIG. 21B, the controller 180 determines a curvature at waypoint data No. x based on the radius rd(x) of the circle CL(x) determined in step S182, for example. For instance, the curvature at waypoint data No. x can be determined as an inverse of the radius rd(x) of the circle CL(x). The controller 180 can determine the curvatures at the respective pieces of waypoint data, and classify them into first sections having a curvature that is equal to or less than a threshold and second sections having a curvature that is greater than the threshold. An example result of classification based on curvature is shown in FIG. 21C. In the graph of FIG. 21C, the horizontal axis represents waypoint No., and the vertical axis represents curvature.

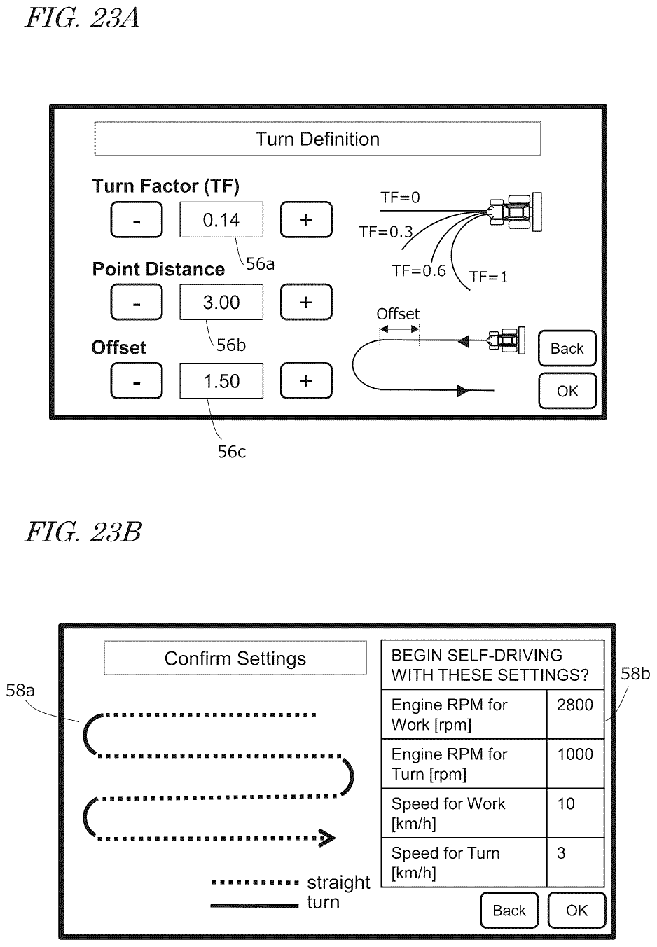

In a case where the curvature of each point in the path is used in classifying a path into first sections and second sections, the curvature may be normalized to a maximum value of all curvatures in the path, thus being represented as a value between 0 and 1. In other words, a value between 0 and 1 can be used as a threshold for curvature, which advantageously makes for the ease of the user in setting or adjusting the threshold for curvature. Moreover, a curvature may be more intuitive to the user than a radius of curvature when indicated in a screen image or on a GUI (see FIG. 23A, FIG. 23B, etc. described below), for example.

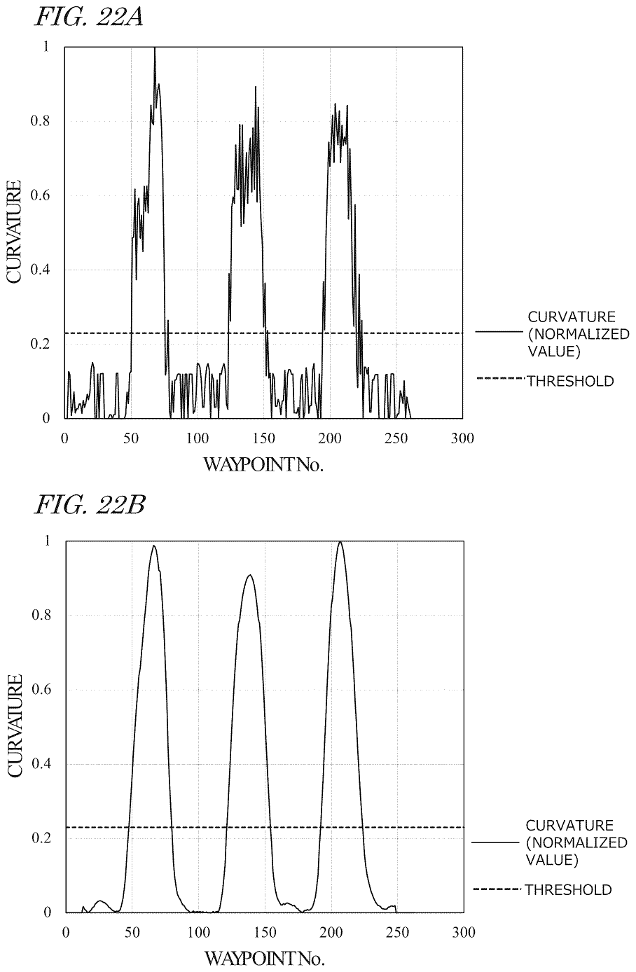

FIG. 22A and FIG. 22B show example results of classifying a path into first sections and second sections. In the graphs of FIG. 22A and FIG. 22B, the horizontal axis represents waypoint No., and the vertical axis represents curvature (value normalized to the maximum value of all curvatures in the path). FIG. 22A shows a result of a case where the interval between three pieces of waypoint data is less than the predetermined distance Dd, and FIG. 22B shows a result of a case where the interval between three pieces of waypoint data is equal to or greater than the predetermined distance Dd. FIG. 22A shows some oscillation occurring between adjacent pieces of waypoint data near the threshold, which is not preferable from the standpoint of classifying a path into first sections and second sections. On the other hand, FIG. 22B shows less noise near the threshold.

The controller 180 may determine a threshold for curvature or radius of curvature based on a user input. The controller 180 may determine the predetermined distance Dd based on a user input. The controller 180 may cause a display to indicate a graphical user interface (GUI) for allowing the user to set a threshold for curvature or radius of curvature and the predetermined distance Dd. Example GUIs are described below.

FIG. 23A and FIG. 23B show examples of screen images to be displayed on a terminal device that is operated by the user performing manipulations in the reproducing mode. The screen image of FIG. 23A includes a GUI for allowing the user to set a threshold for curvature and a GUI for allowing the user to set a predetermined distance Dd. In the screen image of FIG. 23A, the user can set (change) the threshold for curvature based on an input value in a box 56a, and set (change) the predetermined distance Dd based on an input value in a box 56b. The user can also set (change) the length of the portion 36a (FIG. 17) at which the work vehicle 100 is to be decelerated based on an input value in a box 56c.

The controller 180 may further cause an image indicating a result of classifying a path into first sections and second sections to be indicated on a display. The screen image of FIG. 23B includes an image 58a indicating a result of classifying a path into first sections and second sections based on the threshold for curvature and predetermined distance Dd that are input via the GUIs included in the screen image of FIG. 23A. The image 58a is displayed in a form that allows for distinction between portions of the path that have been classified as first sections and portions that have been classified as second sections. In this example, portions that have been classified as first sections are indicated with dotted lines, whereas portions that have been classified as second sections are indicated with solid lines. The portions that have been classified as first sections and the portions that have been classified as second sections may be indicated in different colors.

The controller 180 may cause the result of classification into first sections and second sections to be displayed so as to show dynamic changes in accordance with the threshold for curvature and predetermined distance Dd that are input via the GUIs included in the screen image of FIG. 23A. In other words, when the threshold for curvature and/or the predetermined distance Dd that are input via the GUIs are changed, the controller 180 may allow a corresponding change in the result of classification to be made on the image 58a in real time. While looking at the result of classifying the path into first sections and second sections, the user can set (adjust) the threshold for curvature or radius of curvature and/or the predetermined distance Dd. The contents of FIG. 23A and FIG. 23B may be displayed in a single screen image, whereby the user can enjoy an improved ease of visual recognition.

The screen image of FIG. 23B, in this example, further includes a notification 58b for checking the values set via the GUI included in the screen image of FIG. 16B.

In example embodiments of the present invention, the methods of classifying a path into first sections and second sections are not limited to the aforementioned examples. For instance, the curvature or radius of curvature of the path may be determined by a different method from the aforementioned examples. The controller 180 may acquire information of the angular velocity around the yaw axis of the work vehicle 100 (which may be referred to as a “yaw rate”) based on sensor data that is output from the sensor group 150, and determine the curvature or radius of curvature of the path that is traveled by the work vehicle 100 based on the angular velocity around the yaw axis of the work vehicle 100, for example.

Alternatively, the controller 180 may classify a path into first sections and second sections based on the state of the work vehicle 100. For example, a path may be classified into first sections and second sections depending on whether the work vehicle 100 is in a predetermined travel mode or not. In a case where the aforementioned bi-speed turn mode is switchable between ON or OFF, the “predetermined travel mode” may include the bi-speed turn mode being OFF, for example. For example, the bi-speed turn mode may be turned ON in a turning path, and OFF in a straight path. Therefore, any portion that was traveled with the bi-speed turn mode OFF may be classified as a first section, and any portion that was traveled with the bi-speed turn mode ON may be classified as a second section. In another example, the controller 180 may classify a path into first sections and second sections based on the state of the linkage device 108 for enabling linking of the implement 300.

The travel control systems according to the above example embodiments may be mounted to work vehicles lacking such functionality as an add-on. Such control systems may be manufactured and marketed independently from the work vehicle. A computer program for use in such a control system may also be manufactured and marketed independently from the work vehicle. The computer program may be provided in a form stored in a computer-readable, non-transitory storage medium, for example. The computer program may also be provided through downloading via telecommunication lines (e.g., the Internet).

The techniques according to example embodiments of the present invention are broadly applicable to various kinds of work vehicles for use in smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A travel control system for a work vehicle, comprising:
a positioning device to output position data concerning a position of the work vehicle; and
a controller configured or programmed to:
control operation of the work vehicle;
operate in a recording mode to record to a storage device path data concerning a path traveled by the work vehicle, the path data including multiple pieces of waypoint data acquired based on the position data while the work vehicle is traveling, each piece of the waypoint data including information concerning the position of the work vehicle;
operate in a reproducing mode to control the operation of the work vehicle while causing the work vehicle to travel via self-driving based on the path data;
classify, based on the path data, the path into a first section having a curvature that is equal to or less than a threshold and a second section having a curvature that is greater than the threshold; and
vary a control method for operation of the work vehicle in the reproducing mode between the first section and the second section.

2. The travel control system of claim 1, wherein the controller is configured or programmed to, in the reproducing mode, vary the operation of the work vehicle between when the work vehicle is traveling in the first section and when the work vehicle is traveling in the second section.

3. The travel control system of claim 2, wherein the controller is configured or programmed to, in the reproducing mode, vary a speed and/or an engine speed of the work vehicle between when the work vehicle is traveling in the first section and when the work vehicle is traveling in the second section.

4. The travel control system of claim 3, wherein the controller is configured or programmed to:
determine a first speed of the work vehicle and a second speed of the work vehicle, the second speed being smaller than the first speed;
in the reproducing mode, cause the work vehicle to travel at the first speed while the work vehicle is traveling in the first section; and
in the reproducing mode, cause the work vehicle to travel at the second speed while the work vehicle is traveling in the second section.

5. The travel control system of claim 4, wherein the controller is configured or programmed to determine the first speed and the second speed based on a user input.

6. The travel control system of claim 2, wherein the controller is configured or programmed to:
determine a first engine speed of the work vehicle and a second engine speed of the work vehicle, the second engine speed being smaller than the first engine speed;
in the reproducing mode, cause the work vehicle to travel at the first engine speed while the work vehicle is traveling in the first section; and
in the reproducing mode, cause the work vehicle to travel at the second engine speed while the work vehicle is traveling in the second section.

7. The travel control system of claim 6, wherein the controller is configured or programmed to determine the first engine speed and the second engine speed based on a user input.

8. The travel control system of claim 2, wherein the controller is configured or programmed to:
in the reproducing mode, decelerate the work vehicle while the work vehicle is traveling in the first section; and
in the reproducing mode, accelerate the work vehicle while the work vehicle is traveling in the second section.

9. The travel control system of claim 8, wherein
the path includes a plurality of the first sections and a plurality of the second sections by which the plurality of first sections are connected; and
the controller is configured or programmed to:
while the work vehicle is traveling in the first section in the reproducing mode, decelerate the work vehicle in a portion leading to the second section; and,
while the work vehicle is traveling in the second section in the reproducing mode, accelerate the work vehicle in a portion leading to the first section.

10. The travel control system of claim 2, wherein
the work vehicle has an implement linked thereto;
the work vehicle includes a linkage device to which the implement is connected;
the linkage device includes a three-point hitch to adjust a height of the implement; and
the controller is configured or programmed to, in the reproducing mode, vary the height of the three-point hitch between when the work vehicle is traveling in the first section and when the work vehicle is traveling in the second section.

11. The travel control system of claim 10, wherein the controller is configured or programmed to, in the reproducing mode, ensure that the height of the three-point hitch is higher while the work vehicle is traveling in the second section than while the work vehicle is traveling in the first section.

12. The travel control system of claim 2, wherein
the work vehicle has an implement linked thereto;
the work vehicle includes a linkage device to which the implement is connected;
the linkage device includes a PTO shaft to supply motive power to the implement; and
the controller is configured or programmed to, in the reproducing mode, switch rotation of the PTO shaft ON or OFF between when the work vehicle is traveling in the first section and when the work vehicle is traveling in the second section.

13. The travel control system of claim 12, wherein the controller is configured or programmed to:
in the reproducing mode, turn rotation of the PTO shaft ON while the work vehicle is traveling in the first section; and
in the reproducing mode, turn rotation of the PTO shaft OFF while the work vehicle is traveling in the second section.

14. The travel control system of claim 1, wherein the controller is configured or programmed to, when a manipulation for causing the work vehicle to begin traveling in the reproducing mode is performed by a user:
compare, against a predetermined value, a difference between a position of the work vehicle assumed when the manipulation is performed and a position of a reference start point in the path data at which referencing is to begin with the manipulation;
cause the work vehicle to begin traveling if the difference is equal to or less than the predetermined value;
not allow the work vehicle to begin traveling if the difference is greater than the predetermined value; and
ensure that the predetermined value is smaller when the reference start point is included in the second section than when the reference start point is included in the first section.

15. The travel control system of claim 1, wherein the controller is configured or programmed to, when a manipulation for causing the work vehicle to begin traveling in the reproducing mode is performed by a user:
compare, against a predetermined value, a difference between an azimuth of the work vehicle assumed when the manipulation is performed and an azimuth of a reference start point in the path data at which referencing is to begin with the manipulation;
cause the work vehicle to begin traveling if the difference is equal to or less than the predetermined value;
not allow the work vehicle to begin traveling if the difference is greater than the predetermined value; and
ensure that the predetermined value is smaller when the reference start point is included in the second section than when the reference start point is included in the first section.

16. The travel control system of claim 1, wherein the controller is configured or programmed to:
record, to the storage device, other path data concerning another path that is generated by editing the path data that is recorded in the storage device; and
when a manipulation for beginning editing of the path data is performed by a user:
permit editing of the path data to be begun if an edit start point is included in the first section; and
prohibit editing of the path data from beginning if the edit start point is included in the second section.

17. The travel control system of claim 1, wherein
the path includes a path of traveling in a field;
the first section includes a plurality of parallel main paths; and
the second section includes a plurality of turning paths by which the plurality of main paths are connected.

18. A work vehicle comprising:
a travel control system of claim 1;
a travel device including a wheel responsible for steering; and
a driver to drive the travel device; wherein
in the reproducing mode, the controller is configured or programmed to cause the work vehicle to travel via self-driving by controlling the driver based on the multiple pieces of the waypoint data included in the path data.

19. A method of travel control for a work vehicle to be executed by a controller configured or programmed to control operation of a work vehicle and to operate in a recording mode and a reproducing mode, the method comprising:
in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle;
in the reproducing mode, controlling the operation of the work vehicle while causing the work vehicle to travel via self-driving based on the path data;
classifying, based on the path data, the path into a first section having a curvature that is equal to or less than a threshold and a second section having a curvature that is greater than the threshold; and
varying a control method for operation of the work vehicle in the reproducing mode between the first section and the second section.

20. A non-transitory computer-readable medium including a computer program to be executed by a processor in a controller configured or programmed to control operation of a work vehicle and operate in a recording mode and a reproducing mode, the computer program being executable to cause the processor to perform:
in the recording mode, while the work vehicle is traveling, recording to a storage device path data concerning a path traveled by the work vehicle, the path data including multiple pieces of waypoint data acquired based on position data concerning a position of the work vehicle while the work vehicle is traveling, each piece of the waypoint data including information concerning the position of the work vehicle;
in the reproducing mode, controlling the operation of the work vehicle while causing the work vehicle to travel via self-driving based on the path data;
classifying, based on the path data, the path into a first section having a curvature that is equal to or less than a threshold and a second section having a curvature that is greater than the threshold; and
varying a control method for operation of the work vehicle in the reproducing mode between the first section and the second section.
